(19) United States
(12) Patent Application Publication
(10) Pub. No.: US 2015/0339276 A1
(43) Pub. Date: Nov. 26, 2015

(54) SYSTEMS AND METHODS FOR PRODUCING CUSTOM DESIGNS USING VECTOR-BASED IMAGES

(71) Applicants: Craig J. Bloem, Boston, MA (US); Phillip M. McMannis, Brookline, MA (US)

(72) Inventors: Craig J. Bloem, Boston, MA (US); Phillip M. McMannis, Brookline, MA (US)

(21) Appl. No.: 14/285,122

(22) Filed: May 22, 2014

(51) Int. Cl. G06F 17/22; H04L 29/06

(52) U.S. Cl. CPC G06F 17/2247; H04L 67/42

(57) ABSTRACT

A custom design system is provided that allows real-time design of products by a user and improves the design experience for designing custom products. In one implementation, a system is provided that is capable of scaling vector-based images for various outputs (e.g., printing, display, etc.) without human intervention and without appreciable image degradation. In another implementation, it would be beneficial to allow real-time editing of design data in relation to custom product creation within a client's web browser application. It is appreciated that if a custom product may be designed within a web browser experience, a more seamless design experience may be created for the user. In particular, if design processing were offloaded to the client (e.g., within the web browser), delays in performing certain operations such as saves and updates would be reduced. To this end, a system that provides such capability using vector-based design image formats may be used.

### BACKGROUND

Many conventional approaches exist for providing custom-designed products such as business cards, T-shirts, mugs, among other items. In particular, there exist systems that permit a user to create new computer-based designs that may be printed on standard products, such as printing logos, text and images on such products. Further, there exist other systems that are capable of designing and producing other marketing materials, such as logos, banners, etc., that require the creation of a custom design by a user that may be incorporated within a logo, business cards, promotional products, online advertising, and/or other marketing materials.

### SUMMARY

It is realized that conventional approaches for creating custom designs are insufficient, as provided methods for manipulating image files associated with such designs are non-optimal. In particular, it is appreciated that the design experience for users is not user friendly for the average user of such systems. For instance, users typically need to perform many steps to create a custom design which is outside the capabilities of such users. In one example, a user needs to incorporate imported images, text, and other graphical features into a design which requires apriori knowledge of image files and how to manipulate and create designs with these types of files. Therefore, a more user-friendly interface for designing and producing custom designs would be advantageous. Further, in one implementation, it would be especially advantageous to produce designs that allow the designs to be scaled without human intervention to any particular output type without appreciable image loss.

In one embodiment, at least one print-ready output file is produced that is capable of being printed without any additional steps being performed (e.g., a quality control operator determining whether the output file is capable of being printed). Thus, user-based designs may be printed more economically, as the number of people needed to print the design is reduced. Further, in another example, the system is capable of producing a digital-ready output file which is capable of being displayed within a particular interface, saved in a particular restricted format, or provided in another form which does not require any additional steps. In this way, designs may be displayed, updated, saved, etc. without any additional quality control steps or special knowledge of the user.

According to one embodiment, a custom design system is provided that allows real-time design of products by a user. For example, in one implementation, it would be beneficial to allow real-time editing of design data within a client's web browser application, although it should be appreciated that any number of interface types and technologies may be used to render a client side real time editing application. According to one embodiment, is appreciated that if a custom design may be created within a web browser experience, a more seamless design experience may be created for the user. In particular, if design processing were offloaded to the client (e.g., within the web browser), delays in performing certain operations such as saves and updates would be reduced. Also, processing of image data would be offloaded from server-based systems, and performance of the application would be increased. To this end, and interface may be provided that allows the user to create the custom design within a client's web browser using such technologies including, but not limited to Flash and HTML5 programs that operate on image formats within the browser.

According to another implementation, it is appreciated that a custom design interface of a custom design system and outputs of that system may be improved by using vector-based images rather than raster files for creating and editing design images and text. For instance, there many drawbacks to using raster-based images for creating custom designs, such as, image quality loss, pixelation, and quality issues during printing (e.g., of a customized promotional product) or other type of rendering (e.g., in a display, advertisement, or other media type requiring an image rendering).

Also, it is appreciated that when the raster file needs to be used in another custom design, the raster files may need to be re-created by the user or resized, and thus real-time editing experiences using raster images are not practical or possible. Many times, the image file is unusable as the raster image is typically provided in a predetermined resolution and cannot be applied to different custom design applications.

According to one embodiment, vector-based image tools are used in a custom design system that allows a user to produce a design that overcomes some of the quality issues related to using raster based images. Further, is appreciated that vector-based images may be created once and applied to a number of custom designs without the need for the image to be re-edited or resized.

According to one embodiment, the design system produces a file that is infinitely scalable to one or more applications. For instance, in relation to design and production of custom products, the output file may be beneficial as it produces the same quality for different ranges of products or outputs, and is created at a level that would normally need extensive training or hiring of a graphic designer. Further, according to another implementation, a do-it-yourself website that creates such high-quality images for the design of custom designs would be helpful to a user.

In one embodiment, the well-known Scalable Vector Graphics (SVG) vector-based format may be used, and image data associated with a design may be manipulated within the browser using Flash, HTML5 or other programming method. Although SVG formatted design files may be used, it should be appreciated that other vector-based formats (e.g., Small Web Format (SWF), Encapsulated Postscript (EPS), Postscript (PS), among others) may be used for formatting designs. For instance, using an SVG-based design image, the user may user to produce a design that can be scaled to any size. This capability allows a user to create a design once and the design can be applied to any range of products without the need to be re-edited or resized without the loss of image quality.

According to another embodiment, additional user tools and interfaces are provided to the user to allow them to more easily create and edit custom products. For example, in one implementation, as a user is designing a product or logo (e.g., through a web-based interface), a real-time preview of the product that they are designing may be provided to the user. Also, the user may be presented a real-time preview of other products that are offered featuring the current design being edited. The real-time preview may include the ability to perform 3D transformations (e.g., showing a design curved on a mug/pen or perspective on a product that is laying on an angle). This may be accomplished through real-time image render rather just overlaying a design on the product being designed. As the design is being modified, the image can be updated in real-time rather than re-rendering the image after a brief delay, which would be required if raster-based images were used. Other advantages and capabilities of a vector-based custom product tool are possible and are described below with reference to the accompanying drawings.

Further, it is appreciated that a tool that can render a number of alternative products that are ready to be printed without any operator intervention would be preferable. More particularly, it is understood that the custom design printing process involves much overhead including operators and quality control personnel to review and print custom designs on custom products. It would be beneficial to have a system that allowed users to design their own custom products but yet performed quality and image checking such that review and checking by a printing company was reduced or eliminated. To this end, restrictions and quality checking of the design may be performed by the tool (e.g., to restrict operations using raster-based graphics), and by using vector-based images that have fewer print quality issues, a print-ready design may be produced that can be more easily applied to other custom product types or other image rendering situations (e.g., a display of an image within a digital advertisement).

According to one aspect of the present invention, a system is provided for creating a custom design. The system comprises a client system including at least one processor operatively connected to a memory, an interface configured to receive one or more inputs, the one or more inputs being used to create a design, the design including at least one vector-based design element, wherein the memory of the client system is adapted to store the at least one vector-based design element. The system further comprises a component adapted to modify the at least one vector-based design element and store the modification in the memory of the client system and a component adapted to render the modification of the at least one vector-based design element within the interface.

According to one embodiment, the component adapted to modify the at least one vector-based design element and store the modification in the memory of the client system and the component adapted to render the modification of the at least one vector-based design element within the interface are operable on the client without the need for server-based processing. In another embodiment, the at least one vector-based design element includes image information in at least one of a group of formats comprising Small Web Format (SWF), Scalable Vector Graphics (SVG), Encapsulated Postscript (EPS), and Postscript (PS). According to another embodiment, the interface is configured to accept from the user a design including the at least one vector-based design element includes a browser-based interface through which the at least one vector-based design element is created.

According to another embodiment, the at least one vector-based design element is manipulated using a browser-based editing component. According to another embodiment, the browser-based editing component is implemented using at least one of Flash programming and HTML5 programming. According to another embodiment, the system further comprises a preview interface that is adapted to display, in real-time, an update of the at least one vector-based design element in relation to a base custom product. According to another embodiment, the system further comprises a component adapted to apply a transformation to the at least one vector-based design element to display a modified at least one vector-based design element in relation to the base custom product.

According to another embodiment, the memory of the client system includes a cache that stores the at least one vector-based design element. According to another embodiment, operations performed within the interface of the client system are applied directly to the at least one vector-based design element and updates to a displayed representation of the at least one vector-based design are performed responsive to the operations performed within the interface of the client system without receiving updates from system other than the client system.

According to another embodiment, the system further comprises a plurality of custom product templates upon which the at least one vector-based design element may be rendered. According to another embodiment, at least one of the plurality of custom product templates includes information describing a surface of a custom product, and wherein the processor applies a transformation of the at least one vector-based design element to display the at least one vector-based design element on the surface of the custom product.

According to another embodiment, the system further comprises an interface that is adapted to display the at least one vector-based design element on the surface of the custom product to the user. According to another embodiment, the system further comprises a component adapted to import a raster-based image file and associating the raster-based image file with the at least one vector-based design element.

According to another embodiment, the component adapted to import the raster-based image file is configured to determine a maximum scaling size of the image file relative to an acceptable printing quality of a particular custom product. According to another embodiment, the transformation is performed independently by the client system. According to another embodiment, the system further comprises a component that automatically applies a transformation to the at least one vector-based design element to render an alternative custom product for presentation to the user within the interface.

According to another embodiment, the system further comprises a component adapted to sample one or more aspects of the at least one vector-based design element to render an alternative custom product for presentation to the user within the interface. According to another embodiment, the one or more aspects of the at least one vector-based design element include a color associated with the at least one vector-based design element.

According to another embodiment, the system further comprises a conversion component that is adapted to convert the at least one vector-based design element to an output file having a format. According to another embodiment, the output file format includes a file format that can be printed on a base product by a production system. According to another embodiment, the output file is capable of being downloaded to a client system. According to another embodiment, the output file may be displayed within an interface of a computer system. According to another embodiment, the file format includes at least one of a vector image format and a raster image format.

According to another embodiment, the one or more inputs include inputs provided by a user. According to another embodiment, the one or more inputs include at least one of a group comprising an image, a modification of an image, and a text input. According to another embodiment, the one or more inputs include inputs provided by a user. According to another embodiment, the one or more inputs are received automatically by the system. According to another embodiment, the conversion component operates without operator intervention.

According to another embodiment of the present invention, a method is provided for designing a custom product. The method comprises acts of receiving one or more inputs, creating, using the one or more inputs, a design of at least one custom product, the design including at least one vector-based design element, storing, in a memory of the client system, the at least one vector-based design element, modifying the at least one vector-based design element and storing the modification in the memory of the client system, and rendering the modification of the at least one vector-based design element within the client interface.

According to one embodiment, the acts of modifying the at least one vector-based design element, storing the modification in the memory of the client system and rendering the modification of the at least one vector-based design element within the client interface are operable on the client system without the need for server-based processing. According to another embodiment, the at least one vector-based design element includes image information in at least one of a group of formats comprising Small Web Format (SWF), Scalable Vector Graphics (SVG), Encapsulated Postscript (EPS), and Postscript (PS).

According to another embodiment, the client interface includes a browser-based interface through which the at least one vector-based design element is created. According to another embodiment, the method further comprises an act of manipulating the at least one vector-based design element using a browser-based editing component. According to another embodiment, the browser-based editing component is implemented using at least one of Flash programming and HTML5 programming.

According to another embodiment, the method further comprises an act of displaying, in real-time, an update of the at least one vector-based design element in relation to a base custom product. According to another embodiment, the method further comprises an act of applying a transformation to the at least one vector-based design element to display a modified at least one vector-based design element in relation to the base custom product. According to another embodiment, the method further comprises an act of storing, in a cache associated with the memory of the client system, the at least one vector-based design element.

According to another embodiment, the method further comprises applying operations performed within the interface of the client system directly to the at least one vector-based design element and updating a displayed representation of the at least one vector-based design responsive to the operations performed within the interface of the client system without receiving updates from system other than the client system. According to another embodiment, the method further comprises maintaining a plurality of custom product templates upon which the at least one vector-based design element may be rendered.

According to another embodiment, at least one of the plurality of custom product templates includes information describing a surface of a custom product, and wherein the method further comprises an act of applying a transformation of the at least one vector-based design element to display the at least one vector-based design element on the surface of the custom product. According to another embodiment, the method further comprises an act of displaying the at least one vector-based design element on the surface of the custom product to the user. According to another embodiment, the method further comprises an act of importing a raster-based image file and associating the raster-based image file with the at least one vector-based design element.

According to another embodiment, the method further comprises an act of determining a maximum scaling size of the raster-based image file relative to an acceptable printing quality of a particular custom product. According to another embodiment, the transformation is performed independently by the client system. According to another embodiment, the method further comprises an act of automatically applying a transformation to the at least one vector-based design element to render an alternative custom product for presentation to the user within the interface.

According to another embodiment, the method further comprises an act of sampling one or more aspects of the at least one vector-based design element to render an alternative custom product for presentation to the user within the interface. According to another embodiment, the one or more aspects of the at least one vector-based design element include a color associated with the at least one vector-based design element. According to another embodiment, the method further comprises an act of converting the at least one vector-based design element to an output file having a format.

According to another embodiment, the output file format includes a file format that can be printed on a base product by a production system. According to another embodiment, the output file may be downloaded to a client system. According to another embodiment, the method further comprises displaying the output file within an interface of a computer system. According to another embodiment, the file format includes at least one of a vector image format and a raster image format.

According to another embodiment, the one or more inputs include inputs provided by a user. According to another embodiment, the one or more inputs include at least one of a group comprising an image, a modification of an image, and a text input. According to another embodiment, the one or more inputs include inputs provided by a user. According to another embodiment, the one or more inputs are received automatically. According to another embodiment, the conversion component operates without operator intervention.

According to another aspect of the present invention, a system is provided for creating a custom design. The system comprises a client system including at least one processor operatively connected to a memory, an interface configured to accept from the user a design, the design including at least one vector-based design element wherein the memory of the client system is adapted to store the at least one vector-based design element. The system further comprises a component adapted to automatically scale the at least one vector-based design element without user intervention and a component adapted to render the scaled at least one vector-based design element dependent upon a respective output format.

According to one embodiment of the present invention, the respective output format is a print ready format. According to another embodiment, the print ready format is capable of being printed by a print production system. According to another embodiment, an output rendered by the component in a print ready format is capable of being printed by the print production system without user intervention. According to another embodiment, the respective output format is a digital ready output format. According to another embodiment, the digital ready output format is capable of being displayed in a particular client interface. According to another embodiment, the design includes design image data provided by the user.

According to another embodiment, the component adapted to automatically scale the at least one vector-based design element without user intervention is adapted to scale the design image data to ensure a quality level of the respective output format. According to another embodiment, the component adapted to render the scaled at least one vector-based design element dependent upon the output format is responsive to a predetermined resolution based upon the respective output format. According to another embodiment, the output format includes at least one of a group comprising a display format, a display type, a display area, a display orientation, an output printing format, and a printing substrate.

According to another embodiment, the component adapted to render the scaled at least one vector-based design element dependent upon the output format is responsive to a component adapted to determine a custom product type upon which the at least one vector-based design element is rendered. According to another embodiment, the component adapted to render the scaled at least one vector-based design element dependent upon the output format provides a plurality of scaled vector-based design elements for display on a plurality of custom products. According to another embodiment, the output format includes a defined bounded area identifying an area on a printed product. According to another embodiment, the output format includes an output format that depends upon an output media in which the scaled at least one vector-based design element is represented.

According to another embodiment, the at least one vector-based design element includes image information in at least one of a group of formats comprising Small Web Format (SWF), Scalable Vector Graphics (SVG), Encapsulated Postscript (EPS), and Postscript (PS). According to another embodiment, the interface configured to accept from the user a design including the at least one vector-based design element includes a browser-based interface through which the at least one vector-based design element is created.

According to another embodiment, the component adapted to automatically scale the at least one vector-based design element without user intervention and the component adapted to render the scaled at least one vector-based design element dependent upon the respective output format are operable on the client without the need for server-based processing. According to another embodiment, the interface configured to accept from the user a design including the at least one vector-based design element includes a browser-based interface through which the at least one vector-based design element is created.

According to another embodiment, the at least one vector-based design element is manipulated using a browser-based editing component. According to another embodiment, the browser-based editing component is implemented using at least one of Flash programming and HTML5 programming.

According to another embodiment, the system further comprises a preview interface that is adapted to display, in real-time, an update of the at least one vector-based design element in relation to a base custom product. According to another embodiment, the system further comprises a component adapted to apply a transformation to the at least one vector-based design element to display a modified at least one vector-based design element in relation to the base custom product.

According to another embodiment, the system further comprises a plurality of custom product templates upon which the at least one vector-based design element may be rendered. According to another embodiment, at least one of the plurality of custom product templates includes information describing a surface of a custom product, and wherein the processor applies a transformation of the at least one vector-based design element to display the at least one vector-based design element on the surface of the custom product.

According to another embodiment, the system further comprises an interface that is adapted to display the at least one vector-based design element on the surface of the custom product to the user. According to another embodiment, the system further comprises a component adapted to import a raster-based image file and associating the raster-based image file with the at least one vector-based design element.

According to another embodiment, the component adapted to import the raster-based image file is configured to determine a maximum scaling size of the image file relative to an acceptable printing quality of a particular custom product. According to another embodiment, the transformation is performed independently by the client system.

According to another embodiment, the system further comprises a component that automatically applies a transformation to the at least one vector-based design element to render an alternative custom product for presentation to the user within the interface. According to another embodiment, the system further comprises a component adapted to sample one or more aspects of the at least one vector-based design element to render an alternative custom product for presentation to the user within the interface.

According to another aspect of the present invention, a method is provided for creating a custom design. The method comprises acts of accepting from a user a design within a design interface of a client system, the design including at least one vector-based design element, storing, within a memory of the client system, the at least one vector-based design element, automatically scaling, by the client system, the at least one vector-based design element without user intervention, and rendering the scaled at least one vector-based design element dependent upon a respective output format.

According to another embodiment, the respective output format is a print ready format. According to another embodiment, the print ready format is capable of being printed by a print production system. According to another embodiment, an output rendered by the component in a print ready format is capable of being printed by the print production system without user intervention.

According to another embodiment, the respective output format is a digital ready output format. According to another embodiment, the digital ready output format is capable of being displayed in a particular client interface. According to another embodiment, the design includes design image data provided by the user.

According to another embodiment, the method further comprises an act of automatically scaling the design image data to ensure a quality level of the respective output format. According to another embodiment, the act of rendering the scaled at least one vector-based design element dependent upon the output format is responsive to a predetermined resolution based upon the respective output format.

According to another embodiment, the output format includes at least one of a group comprising a display format, a display type, a display area, a display orientation, an output printing format, and a printing substrate.

According to another embodiment, the act of rendering the scaled at least one vector-based design element dependent upon the output format is responsive to an act of determining a custom product type upon which the at least one vector-based design element is rendered. According to another embodiment, the act of rendering the scaled at least one vector-based design element dependent upon the output format includes providing a plurality of scaled vector-based design elements for display on a plurality of custom products.

According to another embodiment, the output format includes a defined bounded area identifying an area on a printed product. According to another embodiment, the output format includes an output format that depends upon an output media in which the scaled at least one vector-based design element is represented.

According to another embodiment, the at least one vector-based design element includes image information in at least one of a group of formats comprising Small Web Format (SWF), Scalable Vector Graphics (SVG), Encapsulated Postscript (EPS), and Postscript (PS). According to another embodiment, the design interface that accepts from the user a design including the at least one vector-based design element includes a browser-based interface through which the at least one vector-based design element is created.

According to another embodiment, the acts of automatically scaling, by the client system, the at least one vector-based design element without user intervention and rendering the scaled at least one vector-based design element dependent upon a respective output format is performed on the client system without the need for server-based processing. According to another embodiment, the design interface configured to accept from the user a design including the at least one vector-based design element includes a browser-based interface through which the at least one vector-based design element is created.

According to another embodiment, the method further comprises manipulating the at least one vector-based design element using a browser-based editing component. According to another embodiment, the browser-based editing component is implemented using at least one of Flash programming and HTML5 programming.

According to another embodiment, the method further comprises an act of displaying, within a preview interface in real-time, an update of the at least one vector-based design element in relation to a base custom product. According to another embodiment, the method further comprises applying a transformation to the at least one vector-based design element to display a modified at least one vector-based design element in relation to the base custom product. According to another embodiment, the method further comprises an act of rendering the at least one vector-based design element upon a plurality of custom product templates. According to another embodiment, at least one of the plurality of custom product templates includes information describing a surface of a custom product, and wherein the method further comprises an act of applying a transformation of the at least one vector-based design element to display the at least one vector-based design element on the surface of the custom product.

According to another embodiment, the method further comprises an act of displaying the at least one vector-based design element on the surface of the custom product to the user. According to another embodiment, the method further comprises an act of importing a raster-based image file and associating the raster-based image file with the at least one vector-based design element. According to another embodiment, the act of importing the raster-based image file includes determining a maximum scaling size of the image file relative to an acceptable printing quality of a particular custom product. According to another embodiment, wherein the transformation is performed independently by the client system.

According to another embodiment, the method further comprises an act of automatically applying a transformation to the at least one vector-based design element to render an alternative custom product for presentation to the user within the interface. According to another embodiment, the method further comprises an act of sampling one or more aspects of the at least one vector-based design element to render an alternative custom product for presentation to the user within the interface.

Still other aspects, embodiments, and advantages of these exemplary aspects and embodiments, are discussed in detail below. Any embodiment disclosed herein may be combined with any other embodiment in any manner consistent with at least one of the objects, aims, and needs disclosed herein, and references to “an embodiment,” “some embodiments,” “an alternate embodiment,” “various embodiments,” “one embodiment” or the like are not necessarily mutually exclusive and are intended to indicate that a particular feature, structure, or characteristic described in connection with the embodiment may be included in at least one embodiment. The appearances of such terms herein are not necessarily all referring to the same embodiment. The accompanying drawings are included to provide illustration and a further understanding of the various aspects and embodiments, and are incorporated in and constitute a part of this specification. The drawings, together with the remainder of the specification, serve to explain principles and operations of the described and claimed aspects and embodiments.

### BRIEF DESCRIPTION OF THE DRAWINGS

Various aspects of at least one embodiment are discussed below with reference to the accompanying figures, which are not intended to be drawn to scale. Where technical features in the figures, detailed description or any claim are followed by reference signs, the reference signs have been included for the sole purpose of increasing the intelligibility of the figures, detailed description, and claims. Accordingly, neither the reference signs nor their absence are intended to have any limiting effect on the scope of any claim elements. In the figures, each identical or nearly identical component that is illustrated in various figures is represented by a like numeral. For purposes of clarity, not every component may be labeled in every figure. The figures are provided for the purposes of illustration and explanation and are not intended as a definition of the limits of the invention. In the figures:

FIG. 1 is a block diagram of a system for designing custom designs, according to one embodiment of the present invention;

FIG. 2 is an example computer-based process for creating a custom design, according to one embodiment;

FIG. 3 is an example computer-based process for creating a custom design, according to one embodiment;

FIG. 4 is an example process flow for processing vector-based design elements associated with a custom design, according to one embodiment;

FIGS. 5A-5B are an example process flow for processing vector-based design elements associated with a custom product, according to one embodiment;

FIG. 5C shows an example implementation of a design system within a browser environment, according to one embodiment;

FIG. 6 is an example system implementation of a design tool, according to one embodiment;

FIG. 7 is an example interface for creating a custom design, according to one embodiment;

FIGS. 8A-8C are additional example interfaces for creating a custom design, according to one embodiment;

FIGS. 9A-B are screen captures of example user interfaces, according to various embodiments;

FIG. 10 is a screen capture of an example user interface, according to one embodiment;

FIG. 11A is a screen capture of an example user interface, according to one embodiment;

FIG. 11B is a screen capture of an example user interface, according to one embodiment;

FIG. 12 is a screen capture of an example user interface, according to one embodiment;

FIG. 13 is a screen capture of an example user interface, according to one embodiment;

FIG. 14 is a screen capture of an example user interface, according to one embodiment;

FIG. 15 is a screen capture of an example user interface, according to one embodiment;

FIG. 16 is a screen capture of an example user interface, according to one embodiment;

FIG. 17 is a screen capture of an example user interface, according to one embodiment; and

FIG. 18 is a block diagram of a general purpose computer system on which various aspects can be practiced.

### DETAILED DESCRIPTION

Examples of the methods, devices, and systems discussed herein are not limited in application to the details of construction and the arrangement of components set forth in the following description or illustrated in the accompanying drawings. The methods and systems are capable of implementation in other embodiments and of being practiced or of being carried out in various ways. Examples of specific implementations are provided herein for illustrative purposes only and are not intended to be limiting. In particular, acts, components, elements and features discussed in connection with any one or more examples are not intended to be excluded from a similar role in any other examples.

Also, the phraseology and terminology used herein is for the purpose of description and should not be regarded as limiting. Any references to examples, embodiments, components, elements or acts of the systems and methods herein referred to in the singular may also embrace embodiments including a plurality, and any references in plural to any embodiment, component, element or act herein may also embrace embodiments including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms.

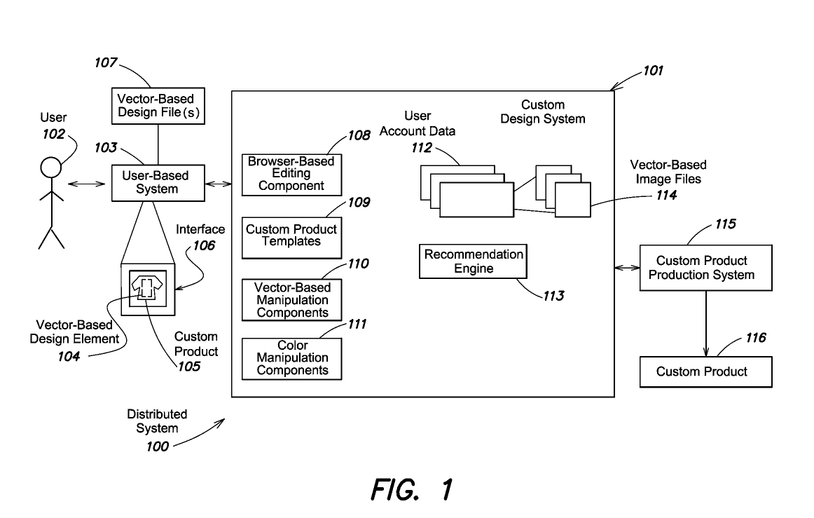

FIG. 1 is a block diagram of an example distributed system 100 for creating and editing designs for different applications, such as, for example, the display of advertising including such designs, developing custom products, among other applications. In one implementation, system 100 may include a custom design system 101 that interfaces with one or more users (e.g., user 102) via one or more user-based systems (e.g., system 103). As discussed, the user-based system 103 may operate with one or more vector-based design files (e.g., files 107) to create one or more custom products (e.g., custom product 116). Such products may include, for example, T-shirts, mugs, or other items that may be produced by a custom product production system (e.g., system 115).

In one embodiment, the custom design system 101 is provided using one or more computer systems that are coupled to the user-based system by one or more communication networks. For instance, custom design system 101 may be web-based such that the user (e.g., user 102) may create a custom design within a web-based interface (e.g., interface 106). In one example implementation, the user may be permitted to design a custom product within the interface by placing one or more vector-based design elements (e.g., element 104) on a visual representation of one or more custom products (e.g., custom product 105).

As discussed above, the user may be provided better tools for creating and manipulating his/her designs, as is appreciated that vector-based design elements can be more easily scaled and manipulated, and may be part of an overall real-time design system. In one embodiment, a client system associated with the user maintains a copy of the vector-based design file in memory and allows the user to interact with the design on the client-side without the necessity to interact with the server. Because this client-based capability is provided, less delay is observed within the user interface responsive to changes in the design. That is, the vector-based design element does not need to be processed and re-rendered within the interface, or processed by server-based entities resulting in delays observed by the user within the editing interface.

In one embodiment, custom design system 101 includes one or more browser-based editing components (e.g. component 108). Such browser-based editing components may include one or more tools that, when rendered within a browser program, allow the user to create and manipulate vector-based images. Further, system 101 may include one or more custom product templates (e.g., custom product templates 109). For example, such templates may include-based products upon which one or more custom designs may be printed, such as mugs, T-shirts or other products. The templates themselves may include information regarding the products such as dimensions, print areas, curvature, background images or other information that may be used to render a visual representation of the product. Although browser-based interfaces can be used, it should be appreciated that other types of interfaces may be used, such as those available in a number of different systems, including, but not limited to iPhone, iPad, and Android interfaces.

System 101 may also include one or more vector based manipulation components (e.g., components 110) which may include one or more interface controls and/or software components that perform actions on vector-based images. Such components may include those that create and/or modify such images (e.g., rotation, stretching, etc.). Further, system 101 may include one or more color manipulation components (e.g., components 111) that perform color-based operations on the vector-based image.

System 101 may also include a recommendation engine (e.g., recommendation engine 113) that is configured to determine and display alternative custom products to the user within the display (e.g., within interface 106). Because system 101 is capable of using vector-based designs, it becomes simpler to determine and display alternative designs to the user on an as-needed basis. For instance, because vector-based designs may be used that can be infinitely scaled to particular products, a logo design intended for a business card may be scaled and displayed on a T-shirt, a curved product such as a pen, or other base product that has a particular requirement (e.g., design orientation). To this end, a vector-based design may be stored in manipulated local to the client to provide such alternate recommendations.

System 101 may also store one or more designs, custom products, and other information associated with the user in a user account data set (e.g., user account data 112). Such information may include vector-based image files 114. Although it is appreciated that such files may be stored in manipulated on a client, such information may be backed up and updated in a storage location may be accessed through a network. For instance, such files may be stored on a server-based system, cloud storage, virtual storage or other storage location.

Once designed, such vector-based designs may be printed on one or more base products such as, for example, business cards, mugs, T-shirts, pens, or other types of products upon which a custom design may be printed. To print on such base products, the vector images may be transmitted to one or more printing systems for rendering on the base product.

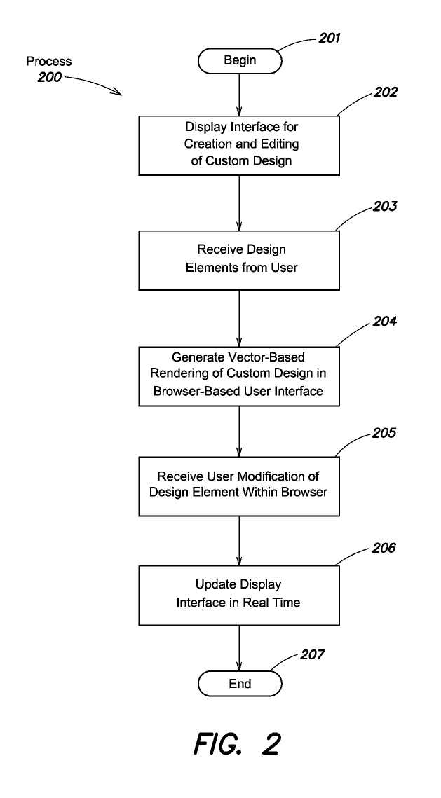

FIG. 2 shows an example computer based process 200 for creating a custom product according to one embodiment of the present invention. At block 201, process 200 begins. At block 202, the client system (e.g., user-based system 103) displays one or more interfaces that allow the user to design a custom product. A block 203, the system receives one or more design elements from a user. Such elements may include, for example, image-based elements that are natively designed within the interface, image files which are uploaded or imported to the system, text-based information, among other types of design information.

At block 204, the system generates a vector-based rendering of a custom product within the interface. For instance, as discussed above, the interface may be a browser-based client interface through which the user can design a custom product including one or more vector-based design elements. At block 205, the system receives a user modification of a design element within the interface (e.g., within the interface of the browser). At block 206, the system updates a display interface in real-time, and the display shows the updated information within the interface. As discussed above, because vector-based design images can be created and modified on the client-side, an interface may be provided that operates in real time, and the user experience is improved. At block 207, process 200 ends.

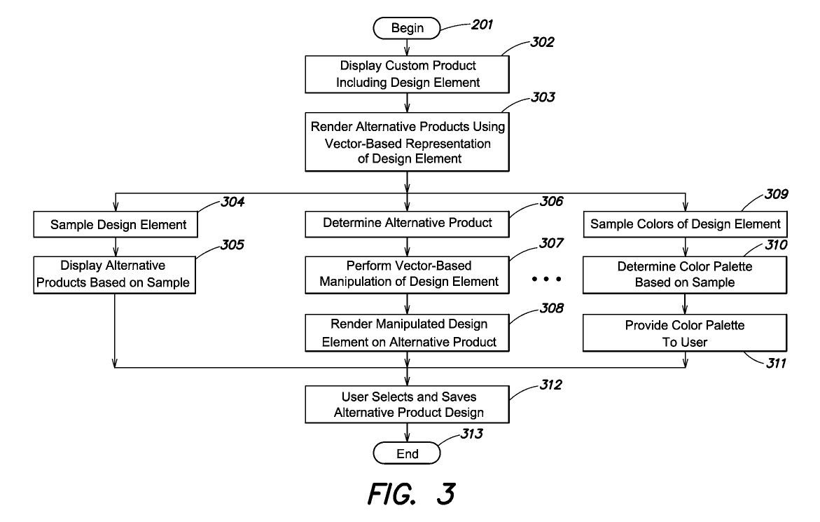

FIG. 3 shows an example computer based process 300 for creating a custom product according to one embodiment of the present invention. At block 301, process 300 begins. At block 302, the system displays a representation of custom product including one or more design elements. At block 303, the system renders alternative products using vector-based representations of the design element.

For example, this can be performed in the number different ways and using a number different features of the vector-based design element. For instance, a block 304, the system may sample the design element and then display alternative products based on the sampling (e.g., at block 305). For instance, the system may take one a portion of the design element (e.g., a logo) and render that element on alternative products. In another example, the system may sample color element within the logo and suggest alternative products that includes that sample color. Other types of processing may be used and repeated for use in an alternative product that is displayed to the user.

In another example, at block 306, the system may determine an alternative product. For instance, a mug other type of product may be determined. At block 307, the system performs a vector-based manipulation of the design element and renders a manipulated design element on the alternative product at block 308. For instance, a logo associated with a business card may be manipulated and displayed on a mug. The mug has a particular size and curvature associated with a viable printing area on a surface of the mug and therefore an appropriate manipulation that takes into account the curvature and resizing of the vector-based image may be performed. In this way, a more realistic representation of a customized product may be presented to the user which may cause that user to purchase the alternative product.

In another example, the system samples colors of the design element at block 309. At block 310, the system determines a color palette based on the sample from the design element, and then the determined color palette may be provided to the user as a tool (e.g. at block 311) for use in designing the current product or an alternative product.

At block 312, the user selects and saves the alternative product design. For example, the user may be presented an option for selecting, within the interface, an alternative design that may have been provided by the system automatically. Thus, the interface provides an easier way to create design additional products using one or more design elements. At block 313, process 300 ends.

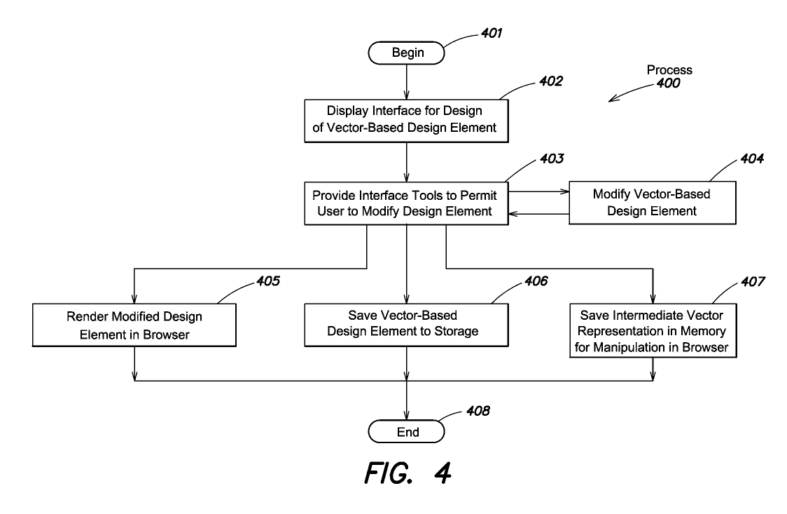

FIG. 4 shows an example process 400 for processing vector-based design elements associated with a custom product according to one embodiment of the present invention. At block 401, process 400 begins. At block 402, the system displays an interface for design of a vector-based design element. As discussed above, the interface may be a browser application interface that operates on a client-based computer system associated with the user.

At block 403, the system provides interface tools to permit the user to modify the design element. According to one embodiment, the tools operate on the vector-based design element in the client application responsive to user inputs. At block 404, the system modifies the vector-based design element responsive to the inputs.

A number of operations may be performed on the vector-based design element, such as, at block 405, rendering the modified design element in the browser, saving the vector-based design element to storage at block 406 (e.g., in some storage location), saving an intermediate vector representation in memory for manipulation within the browser program at block 407, or other operation or manipulation of the vector-based design element. Notably, the intermediate vector representation is manipulated at the client without necessity to contact a server or alternative storage for re-rendering of the design responsive to changes. At block 408, process 400 ends.

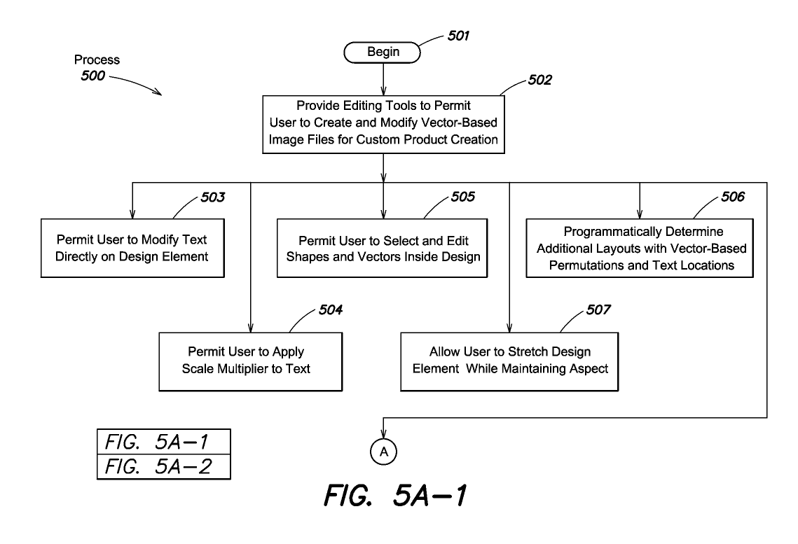

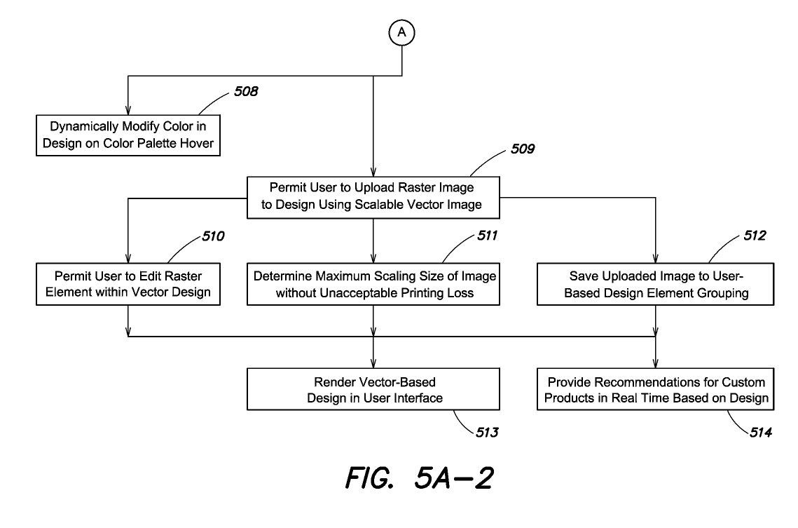

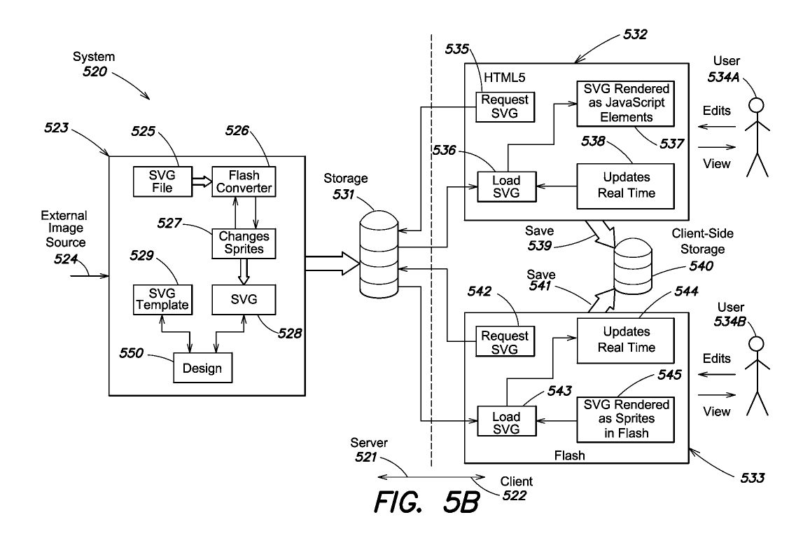

FIGS. 5A-5B show an example process for processing vector-based design elements associated with a custom product according to one embodiment of the present invention. At block 501, process 500 begins. At block 502, the system provides one or more editing tools to permit the user to create and modify vector-based image files for custom product creation. As discussed, the system, as a result of permitting the user to manipulate vector-based image files, may allow additional functionality in a custom product design tool that is not capable of being performed using raster-based files. For example, at block 503, the system permits the user to modify text directly on a design element. In conventional approaches, text may need to be rendered separately from any design images (e.g., in a separate window, field or block). In another embodiment, although a design may be partially data driven (e.g., the design includes text that is created automatically responsive to a user text input or database entry), that text is directly modifiable within the interface. In one implementation, changes made within the interface are reflected in a change in text outside of the design (e.g., in a field value or database).

At block 504, the system may permit a user to apply a scale multiplier to text. In conventional systems, users may be restricted to discrete font sizes, and therefore designs having such restrictions may not be perfect. For instance, a capability may be provided to scale a font size via a multiplier (i.e., a 12 pt font multiplied by 1.2332442 that results in a specific size text on a business card). Also, an ability may be provided to allow a specific font size and multiplier to work together. For instance, a user can select a font size from a drop-down which sets a specific font size, and when the user stretches the text within the canvas, a scale multiplier may be applied to size the text exactly to how large the user desires. This capability allows text of any size and dimension, and the tool may not be constrained by standard font point sizes. The resizing capability, according to one embodiment, may allow users to revert to a standard font size after using the scale functionality. This capability allows users to go back and forth between sizing methods.

At block 505, the system permits a user to select and edit shapes and vectors inside the design and manipulate such selections. For instance, the user may select a particular aspect of the design and the user may select a color (e.g., from a color palette) by moving their selection tool (e.g., a mouse) over different areas of the color palette. Typical programs require user to select a color, preview the color which includes a separate rendering, and an application to the particular design being edited. Rather, by using vector-based images, the user, within the browser program may edit the design in real-time and any actions may be performed directly on the design image being displayed to the user. Further, by using vector-based images, the user may be provided an ability to select and edit individual shapes and vectors within the design, to modify images in real time, a rotate or spin images, or perform other operations or sub operations on the vector-based image.

At block 506, the system may programmatically determine additional layouts with vector-based permutations and text locations. As discussed above, the system may be configured to programmatically suggest additional layouts for logo with set permutations of a logo element and text field locations associated with it. Because elements of the design can be operated on individually (due to the image being a vector-based image having multiple component parts), more permutations of a design are possible, and can be configured as predetermined options for display to the user (e.g., as additional possible layouts, alternative products, etc.). This is helpful to a custom product provider, as the number and configuration of possible products and layouts provided to the user (i.e., a customer) is improved.

At block 507, the system may allow user to stretch a design element while maintaining an aspect ratio. For instance, the ability may be provided to allow the user to scale or stretch a logo while holding an aspect ratio to a constant value. Such capability is not typically provided for raster-based elements.

Further, the system may provide a number of color-based tools for creating and editing vector-based images. For example, at block 508, the system may dynamically modify color in a vector-based design in real time responsive to a hover operation performed on a color palette. In one example, the user may hover a pointing device over a particular color and the selected element within the vector-based design may change color responsive to the hover operation in real time. In this way, colors may be changed within the design dynamically, and various portions of the design may be edited for color individually by the user rather than operating on the entire design.

At block 509, system may permit the user to upload a raster image to a particular design using a scale of vector image. For instance, in one implementation, the system may allow user to upload a raster image file that can be embedded in the design, and which is ultimately saved within the vector graphics file. For example, in one implementation, at block 510, the system may permit the user to edit the raster image within the vector-based design.

At block 511, the system determines a maximum scaling size of an image without an unacceptable printing loss. In one embodiment, when a user uploads a raster image with a fixed resolution into an infinitely scalable vector image, the system may calculate a maximum size to which the image may be scaled without any resolution loss in printing. For instance, this maximum resolution may be a dynamic value and may be based on a particular product. For example, a maximum resolution per printing for a business card could be set at 300 DPI (dots per inch) and a T-shirt at 250 DPI. In one embodiment, the tool may allow the image to be physically larger on the T-shirt because the raster image can be stretched responsive to a determined DPI setting for printing.

According to one aspect of the present invention, the system may be adapted to monitor resolution used in different contexts in real time. According to one implementation, different resolutions may be determined for different applications (e.g., display, printing) and limitations may be enforced within the design application to ensure that quality may be preserved. For instance, in printing, a specific resolution may be used, for example 300 DPI (dots per inch). On an electronic device, however, a different display resolution may be used that corresponds to display pixels, and every device has a PPI (pixels per inch). For example, desktop screens usually have a display pixel value of 72 PPI.

Because, the physical size is known for a particular product (e.g., in inches), the number of pixels may be determined for a particular product in order to keep the density at a desired level. For instance, for a printed product, the resolution is typically 300 PPI. In one concrete example, an image of 600×300 pixels is used. At a 300 DPI print requirement, the display resolution translates to 300 PPI in the display. The image, in this case, may be acceptable for covering only 2×1 inches of the printed product. According to one embodiment, the system may prohibit the user within the design interface for adjusting the image out of a particular tolerance level. For instance, the system may limit the user to expand the image beyond a particular size (e.g., the system determines a maximum area that the user can expand the image based on the maximum permitted image size allowed for printing).

Because the system is capable of recalculating in real-time, the system can impose restrictions on image controls in real-time when the user tries to stretch an image over the maximum image size. In one implementation, this checking may be performed based on inputs by the user when performing editing operations that cause a recalculation and screen update. Conventional design systems allow the user to scale to any size and can only provide an error later, or incorrectly print an inferior product, as such systems do not analyze and limit user operations (e.g., stop the user from stretching the image within the interface) in real-time.

Further, at block 512, the system may permit the user to save uploaded images to user-based design element groupings. For instance, when a user uploads a raster image to place in a specific design, the system may also load that raster image into a portfolio of saved designs so that the image may be used later. For instance, the image may be used by the user in different designs without the necessity to upload the image, may be used by the system to show alternative designs of other products having that image placed on the products. Such placement is important, as a user may typically only want a design portion (e.g., a logo) to appear on an alternative product that might be suggested to the user.

At block 513, the system renders a vector-based design in the user interface. For example, the vector-based design may be displayed to the user in a display window such as a preview window or a real-time editing window for design the product. Also, in an alternative embodiment, the system may provide recommendations for custom products in real time based on previous designs at block 514. For instance, as a user is editing a logo for a business card, that logo may be shown within another interface for an alternative product. Such alternative products may be selected based on user behavior, information within the design, text within related areas of the design, information regarding the user, or other behavioral, environmental, or user-based information.

Other capabilities may be provided that allows the user to more easily and create designs for custom products. For instance in one embodiment, designs may include templates behind them that includes areas for elements to be auto populated and/or auto fitted. Examples include adding an email address on a business card and changing the font size automatically to automatically fit that email address in an allotted area. Another example includes labeling an area on a business card for logo or image and when the user uploads or picks a logo, the system auto scales and places the logo so that the user does not need to make any adjustments.

Further examples include an ability to tie specific user data to specific locations for render by default in a design. For example, the system may be capable of indicating a location to place data from a user in a design and automatically place that specific data from the user (e.g., responsive to user input or data previously stored in a database) when the user loads the design. Other examples include the ability to set vector-based elements as movable or non-movable in the design, the ability to set elements and editable or non-editable in the design, among other abilities to operate on separate elements of the design.

In yet another embodiment, the capability may be provided to show a live preview of the design of one or more physical products in real time as the design is being edited with near zero lag. For example, if a user starts moving an element in a particular design, the view of the edited design is updated in real time, and there is no appreciable waiting until the user has finished moving the design to update the interface. In one example implementation, the visible view is updated as the user moves an element pixel by pixel.

Such abilities may also be used to apply 3-D transformations of the designer real time as the design is being edited by the user. For example, if the user starts moving an element in the design and the system applies a curvature to show what the design would look like on the product (e.g., a mug) the system may apply the curvature in real time to show the image as the user is moving it. Therefore, there is no delay in updating the design if the user would like to see a rendering of an image in a particular location. Also, in ability with is provided to flip to a different side of a design directly within the editor without needing to reload page information or data. Most conventional products require a “move to back” function that loads a different page or reloads the page, both of which are not real-time views responsive to changes.

As discussed, one advantage of working with vector-based images includes having designs that can be infinitely scalable. The value in this is that a user is permitted to create one design of any size that will be guaranteed to work without any loss of quality or resolution in any other size. One example includes having a design for business card that can be instantly scaled to a letterhead format without the necessity to resample the design.

One implementation that may facilitate such ability may include a hybrid design of both vector and raster elements while keeping each design within specifications for print purposes. For instance, an editor function to be provided that is capable of manipulating a raster image within a vector-based image design and limiting how much the raster image can be scaled in physical print size (e.g. based upon a printed product).

A web interface may be provided that works with such image formats within a browser window. For instance, in intermediate vector-based file format may be used to manipulate and design images. For instance, a vector-based format may be used as an intermediate format. In one implementation, and SVG format may be converted to SWF and an SVG file may be created upon a save operation. In HTML5, SVG elements may be converted to JavaScript/HTML5 elements which allow editing, and then the elements are converted to an SVG file format on a save operation.

FIG. 5C shows one example of a distributed system 520 that may be used to create a design according to one embodiment of the present invention. For instance, as discussed above, a system that uses SVG or other vector-based image format may be used to create designs within a browser environment. In one implementation, a server-based system, SaaS model, or other method for distributing an application may be used to support a browser-based design system.

As shown in FIG. 5C, on a server (521) side, a system 523 uses a design image provided in, for example, an SWF-formatted file (e.g., file 525) to be used in an SVG-based design (e.g., design 550). Such a file may be provided, for example, by an external image source 524, such as stock photos, images, or other image provider. File 525 is converted to an SVG format via a flash converter (e.g., converter 526), which changes the image to a number of sprites (at 527) which form the SVG image (e.g., image 528). The SVG image may be combined with an SVG template (e.g., template 529) to form a design. The design and its associated components may be stored in online storage (e.g., storage 531) where it can be accessed and manipulated by a client-based browser application.

As discussed above, one browser implementation on a client side (e.g., 522) may be programmed using HTML5 (e.g., system 532) and another implementation may be programmed using Flash (e.g., system 533). In an HTML5 implementation, there may be a component (e.g., element 535) that requests an SVG design from storage (e.g., storage 531). Another component (e.g., element 536) may be provided that receives the SVG design from storage (for instance, a combination template and image, or template and image referenced separately). According to one implementation, the SVG design may be rendered as JavaScript elements by a component that executes within the browser (e.g., element 537). Notably, as a user (e.g., user 534A) may interact with the design as rendered within the browser, and updates in real time may be processed on the client and stored locally by the client (e.g., within client-side storage 540). For instance, as a result of a save operation 539, the design may be stored local to the client.

In a similar way, a Flash version (e.g., system 533) of a browser application may be provided that allows a user (e.g., user 534B) to perform updates in real time on a client system. System 533 may also include a component (e.g., element 542) that requests an SVG design from storage (e.g., storage 531). Another component (e.g., element 543) may be provided that receives the SVG design from storage (for instance, a combination template and image, or template and image referenced separately). According to one implementation, the SVG design may be rendered as sprites in Flash by a component that executes within the browser (e.g., element 545). Notably, as a user (e.g., user 534B) may interact with the design as rendered within the browser, and updates in real time may be processed on the client and stored locally by the client (e.g., within client-side storage 540). For instance, as a result of a save operation 541, the design may be stored local to the client.

Also, it should be appreciated that by saving design information in SVG format, a capability to provide highly customer suggestions may be possible. For example when someone designs the logo, the system may easily analyze color usage and use the most popular colors to suggest business card designs with alternative colors to match the logo. Such a process is advantageous, as this operation can be done without user intervention, may result in alternative product sales, and can be customized for a particular user. In another example, an ability may be provided to import vector files by converting them to Flash/SWF, which can be converted to an SVG file on a save operation.

In a typical implementation, users are provided a preset color theme including matching color values. In such a situation, users conventionally pick a particular color theme when setting up a design (e.g., from a template provided by the system). According to one aspect of the present invention, the system analyzes the color usage in a user-created design in real time, and provides alternatives to the user or otherwise reacts to color-based usage information as it changes in the user's design.

In one implementation, an image rendering engine may be provided that allows a user's design to be rendered without the need for caching or a content delivery network (CDN). In one embodiment, and image rendering API may be provided that takes a vector-based design image (e.g., in SVG format) and creates a raster rendering at a specific size and sends the rendered image directly to the user's browser application. In one embodiment, the API may be capable of displaying recommendations for products using a user's specific design. In one implementation, the system may implement an algorithm for searching and determining recommendations for products, and may call the API to render specific images within the interface. In another implementation, a process may provide a cookie to a user system that uniquely identifies users, their preferences, and may identify any designs that they have used or created, and the API may be called to render such designs to the user.

In another implementation, the image rendering API may be called to render unique images to be included in directed emails to particular users. Because the emails may be generated based on user-specific data (including any design data), such emails may be customized for particular users. This feature is beneficial, as in direct email marketing campaigns, custom images can be generated on-the-fly without the need to store or access such images in a CDN. Also, because users are associated with certain designs, it follows that security measures may be used for accessing certain designs (e.g., by user, IP address, password, or other security information, either alone or in combination).

Further, it is appreciated that custom images may be generated on-the-fly without the need for storage, such technology may be used by other applications. For instance, email marketing systems may include such technology for generating custom images for marketing to particular consumers. Such images may be specifically targeted to individual and/or groups of consumer users based on information known about such users including demographics information, behavioral data, data regarding other users, among other information.

Also, it is appreciated that such images need not be cached by email service providers (e.g., gmail, Yahoo! Mail, hotmail, etc.) Also, because email service providers do not cache images, it may be possible to track open rates and other behavioral data that is not possible when static images are used. Further, the images may be generated dynamically when they are accessed by a user, so a previously sent email may have different image data generated when the email is accessed.

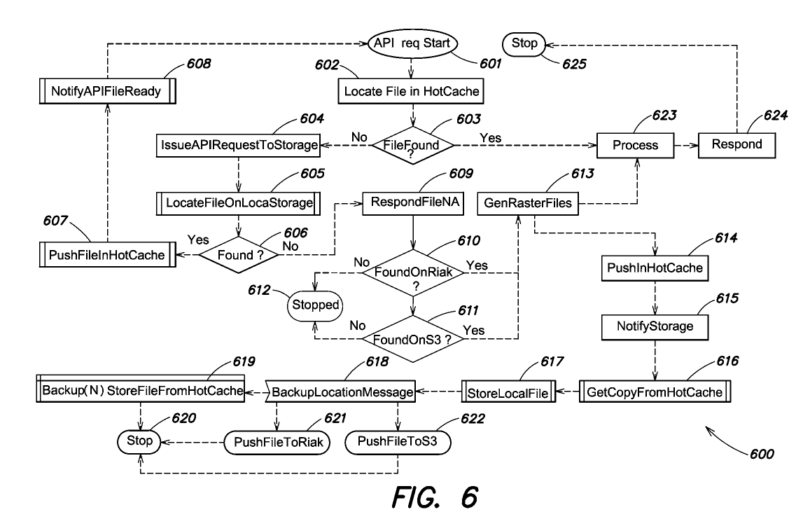

FIG. 6 shows an example implementation of a custom design tool which is backed up by a scalable storage system according to one embodiment of the present invention. In one implementation, a storage system is built using a memory cache for immediate file access at high speeds (e.g., a hot cache entitled HotCache in FIG. 6), a queue message, and two or more storage servers. In one implementation, the system may also be backed up by a database server (e.g., a Riak cluster or other suitable technology) and online storage (e.g., cloud storage) or any other service or mechanism for saving design data. One performance goal of an example implementation includes providing a system that does not lose the vector-based image files created by users. In one embodiment, the storage system may be implemented such that critical system files (like SVG source files) may be separated from the remainder of files generated in secondary operations for various purposes (e.g., raster files, other data files).

As shown in FIG. 6, the application “starts” at 601, and at 602, a file is located in HotCache. If the file is found at 603, an image rendering process is executed at 623, and the image is provided to a calling program in a response at 624. At block 625, process 600 ends. If the file is not found, a request to storage is made at block 604, where the file is located in storage at 605. If found at 606, the file is “pushed” to HotCache at block 607. At block 608, the application is notified that the file is ready. If the file is not found, a response is provided at 609, and it is determined whether the file is located within a database (e.g., a Riak cluster at 609) or if not, a remote storage location (e.g., in an Amazon S3 storage system at 611). If the file is not located, an error may be produced and the process is stopped at 612.

If the file is found on remote storage, raster images may be generated at block 613, the image rendering process is executed at 623, and the image is provided to a calling program in a response at 624. In one embodiment, each API may place any new generated files into the HotCache (e.g., at block 614). At the same time, a main file storage server may be notified by an API call (e.g., at block 615) that there is a new file ready to store. The main file storage server retrieves a copy of the file from the HotCache at 616, then the server posts a message into the messaging queue. This message is processed by workers from the auxiliary storage servers having the result of getting also a copy of the file from the HotCache on each backup server defined. The server then posts a message into the messaging queue that is processed by a dedicated worker responsible for pushing a copy of critical files to remote locations (e.g., like a Riak cluster at 621 and Amazon S3 at 622).

In summary, when a file is requested by any of the APIs, the first place which is inspected is the HotCache. If the file is older than a predetermined time (e.g., 1 hour), the main storage server is notified to push a copy of the file into the HotCache. If for some reason the file is not located in the storage and is not a critical file, the SVG file is pushed into the HotCache. Based on the file, any needed files are generated again. The notification system works as described above to ensure distribution of files across all storage backup servers. SVG files are retrieved from local storage if found, if not from one of the two remote backup locations (Riak cluster or Amazon S3). In case of a failure of main storage, the balancer routes all API storage requests to one of the backup servers left active. This will ensure read/write operations and keep a website associated with the tool operational.

Regarding the API and image processing flow, the process may begin with a loading of an image in vector image format. In one implementation, the vector images may be then converted to an SWF file format (Flash file format), which is also a vector format file. In this case, all information from the initial vector image file may be stored within the SWF file. The newly-created SWF file is converted to SVG, and then provided for review, adjustments, among other additional settings. When complete, the changes are saved as a new SVG image. This is the point where the first SVG image used as a model in created. At the same time, a raster image may be created but without the sample text on the design (e.g., only a background with an icon) at a standard view resolution. This image may be used to generate image previews in a later selection process.

In the case of generating logos by an API to publish, an API call may be made to an API render server (e.g., an API that renders an image). Each request like this, will make the API to locate the desired logo identifier, retrieve the background raster image (e.g., an empty copy of an SVG design file), apply the user input text over it, then send the image to be rendered. Positioning info may be provided that determines where the text should be placed.

Once a logo is selected, the editor loads into the page, then it makes a series of calls back to servers or other system types to load: a specified logo SVG file, an XML file for initial text positioning and some editor other settings, a list of available fonts and a small sample image that shows how font looks like (font preview) and an active font file is loaded into the editor. According to one implementation, actions the user is making from this point forward may be handled entirely by the editor on the client side. As discussed, such actions may be implemented by programming (e.g., in Flash and/or HTML5) on the client side. In one specific embodiment, nothing the user does requires a background call to the server and no raster images are used at this point (except for the uploaded user files).

Once the user finishes any changes, all transformations that were performed are converted to SVG instructions, new SVG headers are created and the entire structure is sent back to a server or other storage location to be saved. At the same time, the editor (both HTML5 and Flash) sends to the server also the preview raster image. This system allows for the showing of a real time preview without the need to do a server call that creates the raster image, and all operations, according to one embodiment, are performed on the client system. Once the new SVG and raster image are loaded to the server, they are stored for future use.

### Example Interfaces

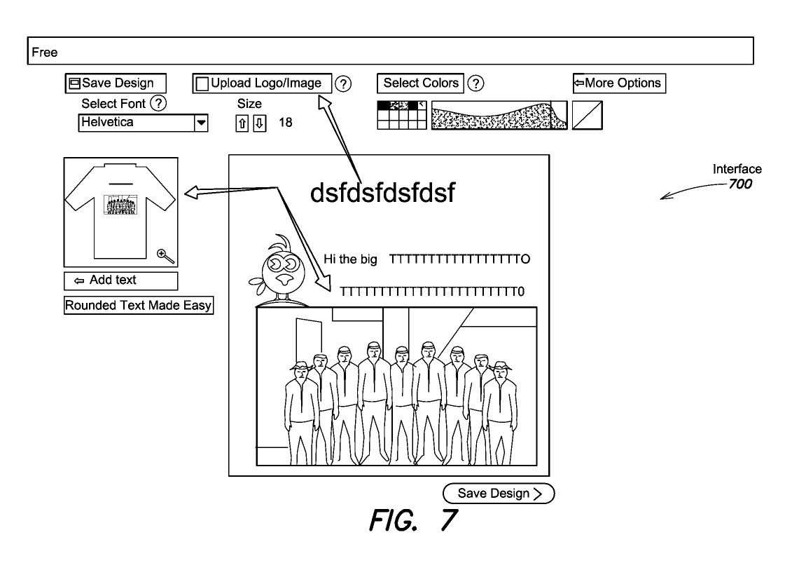

FIG. 7 is an example interface for designing a custom product according to one embodiment. In particular, FIG. 7 shows an interface 704 that may be used to design a custom product. Interface 700 may include a design window in which the user edits a particular image. Interface 700 may also include a preview window which shows the created design as rendered on a product. As a user makes edits within the design window, updates are applied simultaneously to the preview window. Further, interface 700 may include the ability to upload image data to be included within the design. As discussed above, the image may be uploaded in a raster format and may be associated with a vector-based image.

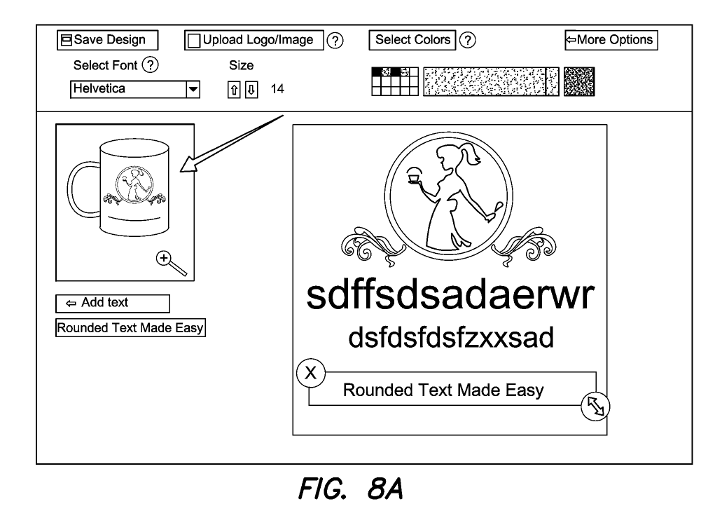

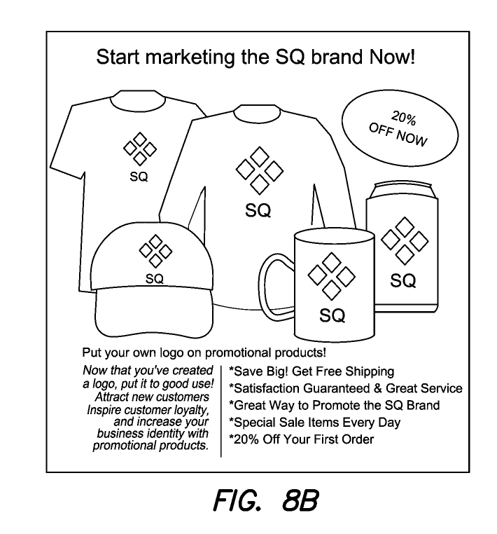

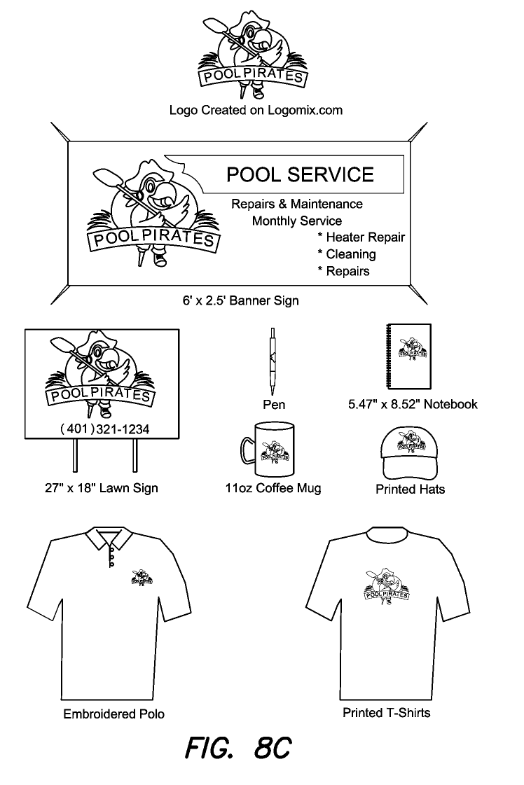

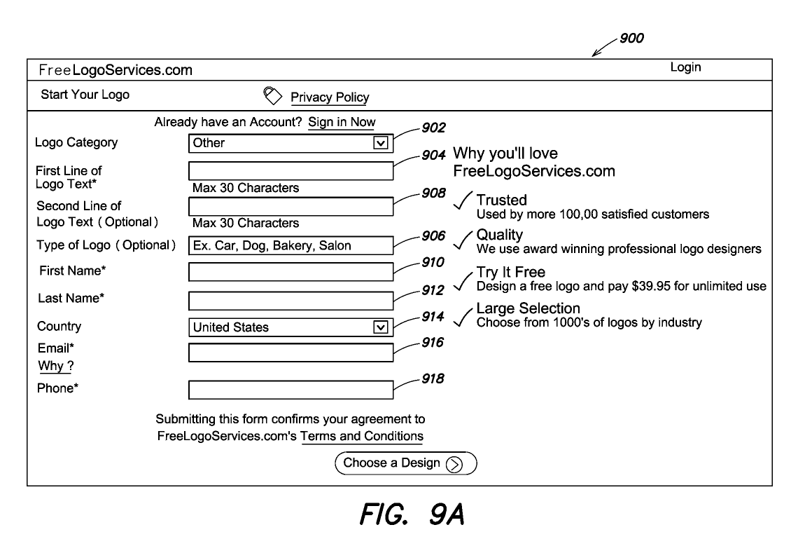

FIG. 8A shows another example interface for designing custom product according to one embodiment of the present invention. As shown, the design interface shows a two-dimensional design with associated text within the design window. However, within the preview window, is a mug that has a rounded edge and the vector-based graphic included within the design window is applied to the surface of the mug by performing a transformation on the vector-based preview image.

FIG. 8B shows another example of an interface for designing custom products according to one embodiment of the present invention. As discussed above, recommendations may be made to a user within an interface of a computer system. For instance, within a browser program, an advertisement may be shown which recommends particular custom products. The system may take one or more vector-based designs that were used by the user to render them within a particular interface on one or more different products (e.g., shirts, caps, mugs, or other items). Because the images are rendered in a vector-based format, such images may be easily applied to other custom products which may require adjustment of the image according to dimensions and surfaces of the product.

FIG. 8C shows a variety of templates that may be used to render designs. For instance, for a logo created within a browser interface, the logo may be adapted to be displayed and/or printed on various custom products. Because the design (e.g., a logo) is rendered in a vector-based graphic format, the logo may be adapted to any number of custom products, print areas, orientations, or other output parameter. As discussed above, restrictions may be implemented which determines a limitation relating to the image sizing to ensure an acceptable output resolution (e.g., a display resolution, a print resolution, etc.).

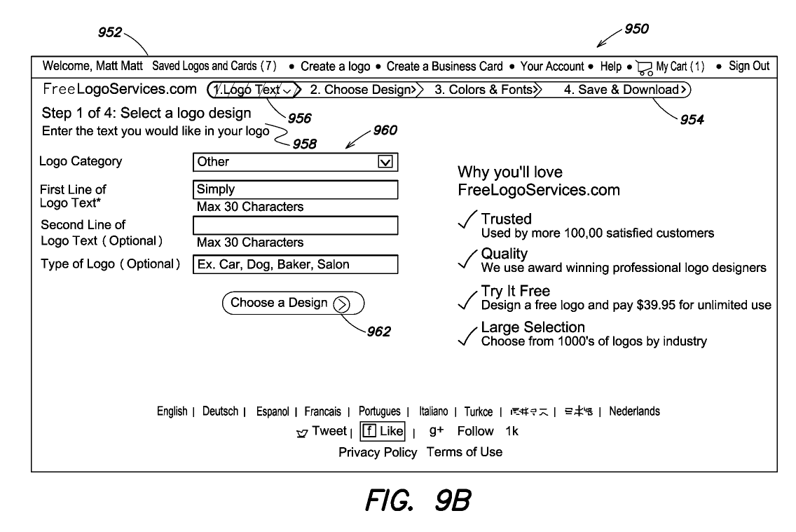

In one embodiment, an Internet site (e.g., the freelogoservices site accessed at a number of locations such as LogoMix.com, FreeLogoServices.com and PrintingNow.com) can be configured with a step-based approach to purchasing a custom product/creating a logo design. In the first step, the user can provide descriptive information on the custom product the user would like to create. For example, various text input fields can be presented to elicit information regarding a logo the current user wishes to design. FIG. 9A shows an example user interface 900 that can be accessed to begin creation and purchase of a custom design, such as a company logo. The user may specify a logo category (e.g., 902), text to include with the logo (e.g., 904), and a type of logo they wish to create (e.g., 906, FIG. 9A). The interface can be configured to accept multiple lines of logo text (e.g., 908). In some embodiments, the user is prompted to input their name (e.g., first and last names 910-912). Other user information can be required, country 914, e-mail 916, and phone 918 information. In one example, by default the logo category is selected as “other” to provide access to all available logos. In one alternative, the logo category field can be blank where a user has not selected a category. Once the user has input required information, the user may select 920 “Choose a Design” to move to the next step of the design process.

In some embodiments, the user interfaces may vary based on whether a new user is creating a logo (e.g., FIG. 9A) or a returning user is creating a logo (e.g., user interface 950 of FIG. 9B). Returning users can be provided header displays for navigating within the freelogoservices site (e.g., at 952). The header 952 can identify the current user “Matt,” any available saved products (e.g., “Saved Logos and Cards (7)), and other functions accessible on the site: Create a Logo, Create a Business Card, Your Account—for defining account information and user profile information, Help, and sign out functions, among other options. User interface 950 can also include a status display 954 reflecting steps for completing a purchase of a custom logo. According to one embodiment status display 954 can include a progress bar showing each step: “1. Logo Text,” “2. Choose Design,” “3. Colors & Fonts,” and “4. Save & Download.” According to one embodiment, user activity within each step can be scored according to the step in which the activity occurred. Highlights within the status bar can be configured to reflect a current step or level (e.g., at 956). Page listing information can also be configured to reflect a status for creating the custom logo (e.g., 958). At 960, information for the logo the user wishes to create can be input (e.g., logo category, first line of logo text, second ling of logo text, and type of logo, among other options). Once input, the user may process by selecting 962 “Choose a Design.”

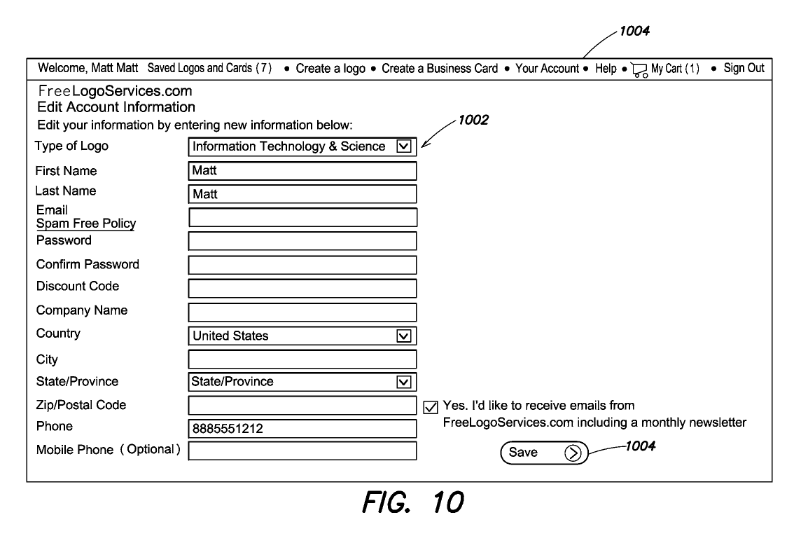

Alternatively, user may access account information by selecting “Your Account” in the header bar 952. FIG. 10 shows an example user interface 1000 for managing account information. Users can enter, manage, and/or change their account information at 1002. For example, users may specify a default logo type, first name, last name, email, password, confirm password, discount code, company name, country, city, state, zip, phone, mobile phone, among other options. Any changes can be saved by selecting 1004. Upon saving changes, the user can be re-directed to whatever page they were previously accessing. Alternatively, a user may select functions from the header display of 1000 (e.g., at 1004) to return to logo design functions.

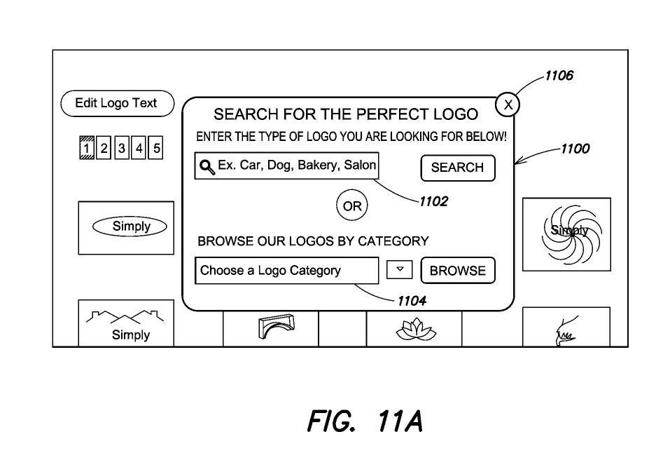

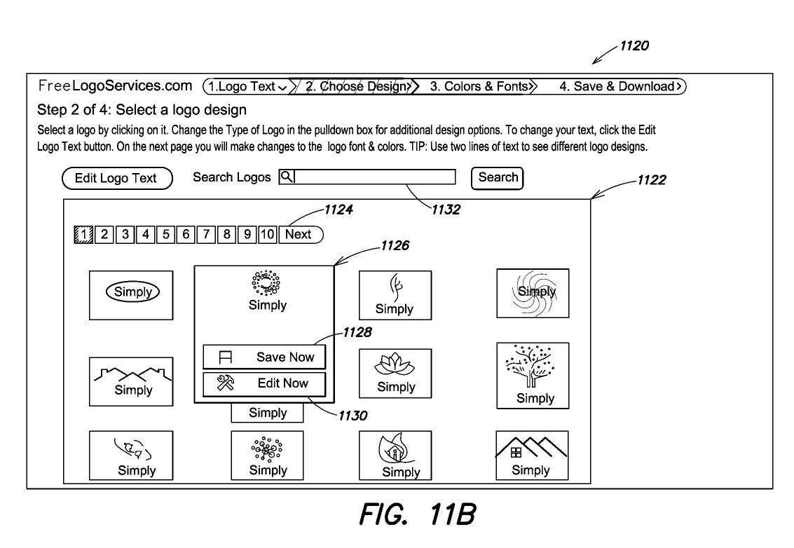

Returning to FIG. 11B, once the user selects 1162, the system transitions to a next step of the logo design process. In one example, the system provides an overlay display to prompt the user to further define their needs for a customer logo. Shown in FIG. 11A is an example user interface 1100 that can be displayed over a design interface (e.g. FIG. 11B). In one example, UI 1100 is displayed when the user has not specified a logo category or logo type they would like to create. At 1102, the user can input a logo type which the system uses to search existing logos or at 1104 a logo category can be selected from a drop down list. The drop down list can include pre-defined categories. In some embodiments, user activity can be used by the system to automatically generate new logo categories. The new categories can be selected from the drop down menu 1104 once generated by the system. If the user has specified a logo category (e.g., at 1104) or a logo type (e.g., at 1106) or closes UI 1100, the system displays user interface 1150 of FIG. 11B. For the purposes of clarity, the common elements between the various user interfaces may not be described with respect to each Figure.

FIG. 11B shows a user interface 1120 for selecting a respective design. User interface 1120 can include a selection display section 1120 for rendering candidate designs. Multiple pages of design options may be available, which can be accessed by selecting page links or next at 1124. Additionally, the user may filter the displayed logo options by entering search terms in input box 1132.

In one embodiment, UI 1120 is responsive to a hover action by users. For example, if a user places a mouse pointer over a particular design option, that design option will be rendered with a selection/edit border 1126. Within the border 1126, the user may select “Save Now” at 1128, which results in the system saving the logo design and transition the user to purchase displays. Alternatively, the user can select “Edit Now” at 1130 to access design editing functions.

Not readily apparent, each action taken by the user can be stored, for example, on the system hosting freelogoservices.com (or other site location). The user actions, user information, and optionally scores for the action can be associated with the logo being designed, as well as any logo text, or logo search terms entered. As discussed above, the accumulation of user actions can be used to influence subsequent displays of logo designs.

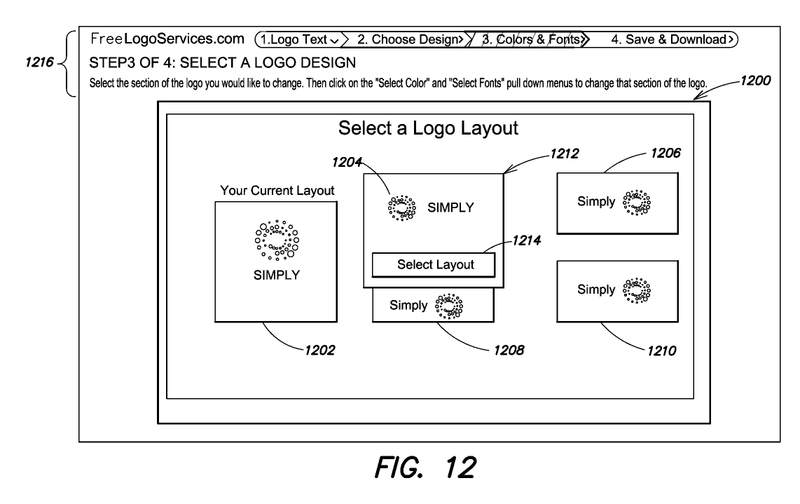

According to one embodiment, responsive to selection of 1130, the system can display an overlay screen 1200 as shown in FIG. 12. The overlay screen 1200 can be configured to present layout options to the user. Each layout option can be ordered similarly to logo design ordering. In one example, user historical selection of similar logos and/or text can be used to determine what layout options should be presented to the user. Layout options can be scored using historical user activity, as discussed above, and ordered based on a respective score. In other examples, historical user activity associated with layout options can be filtered based on using models/characteristics matching the current to further refine any ordering of selections. At 1202, a current layout is presented to the user based on logo design selections made in previous screens. Additional layout options can be displayed at 1204-1210. Each layout option can be responsive to a hover action by a user. If the user moves a pointer on the display over the layout option, a selection border will be displayed (e.g., at 1212). Responsive to selection of the selected layout (e.g., at 1214), the system transitions to an editing user interface. In some embodiments, overlay screen 1200 is displayed over a grey out background 1216. The grayed out background 1216 can reflect what will be shown to the user as the editing interface upon selection of layout.

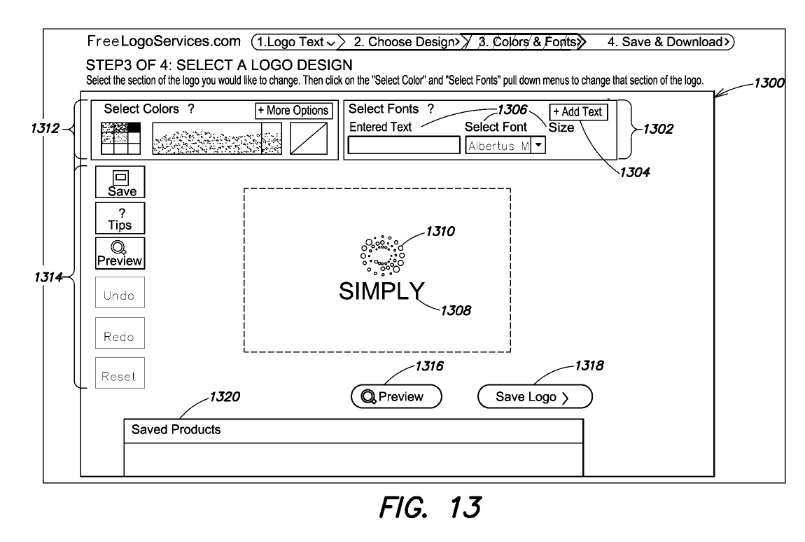

FIG. 13 is an example screen capture of an editing user interface 1300. The editing UI can include text management tools (e.g., at 1302). The text management tools can provide for adding new text (e.g., at 1304), manipulating text characteristics (e.g., font, size etc. at 1306). The text management tools can be configured to manipulate the exiting text “SIMPLY” at 1308. The editing UI can also include color management tools (e.g., at 1312). The color management tools can be configured to manipulate the display colors of any text in the logo design, as well as the colors presented in a logo image (e.g., at 1310). The color management tools can also include selections configured to provide additional functionality. In one example, the additional functionality can provide for popular color selections. In some embodiments popular color selections can be presented based on scoring of prior user selections.

At 1314, display 1300 includes file management functions. The file management functions provides for saving a design, accessing design tips, accessing a preview image, undoing edits, redoing edits, and resetting a logo to original format, among other options. Additionally, a user can access a preview of their design responsive to selection of 1316. The system saves any edit to the logo design responsive to selection of 1318 in interface 1300. According to one embodiment, any saved products that a user has designed, saved, and/or purchased can be displayed as part of the editing screen 1300. For example, at 1320, images of previously saved logo designs can be displayed. Additionally, recommendations for products (e.g., novelty items, coffee mugs, hats, t-shirts, etc.) incorporating the current logo design and/or prior logo designs can be displayed within the saved products display area 1320. Not shown, the saved products display area can include functions for purchasing the displayed product or logo as well as functions to edit the displayed product or logo. In some embodiments, each of the displayed products and/or logos can also be scored based on prior user interactions as discussed above, for example, with respect to content items and logo designs.

In some embodiments, selection of save logo at 1318 triggers the system to display a preview of the logo design. The preview window requests that the user confirm the layout of the logo design prior to saving. If the user is satisfied (e.g., selects save in the preview display), the system saves the logo.

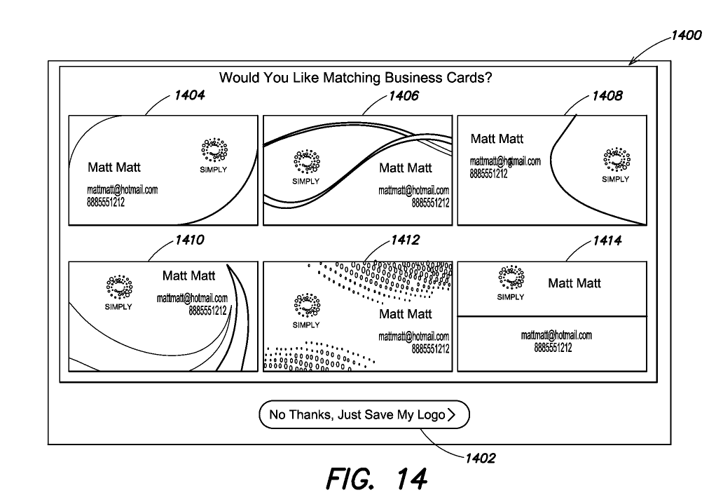

According to another embodiment, the system can be configured to present custom products to the user responsive to saving of a logo design or other action. In one implementation, the logo design may be saved in memory when changes are made to the design by a user. According to one example, an overlay display 1400 FIG. 14 can be shown responsive to saving a logo design. The overlay display 1400 can be configured to present candidate business cards incorporating the current user's logo design, along with user account information (e.g., first and last name, e-mail, and phone number). Each of the business card options (e.g. 1404-1414) can be automatically generated for presentation to the user. In some embodiments, the business card options can be selected by the system for display based on scoring of prior user history. In other embodiments, the system can be configured to select the elements of each business card design (e.g., any one or more of: color, image, layout, text, font, etc.) based on scoring of the elements based on prior user history, as discussed above. In yet other embodiments, the system can select popular layouts and incorporate the current user's logo design. Responsive to selection of a business card, the system transitions to an editing display for the business card (e.g., similar to display 1500). If the user does not wish to design a business card, the user may select 1402 to finalize the saving of the current user's logo design.

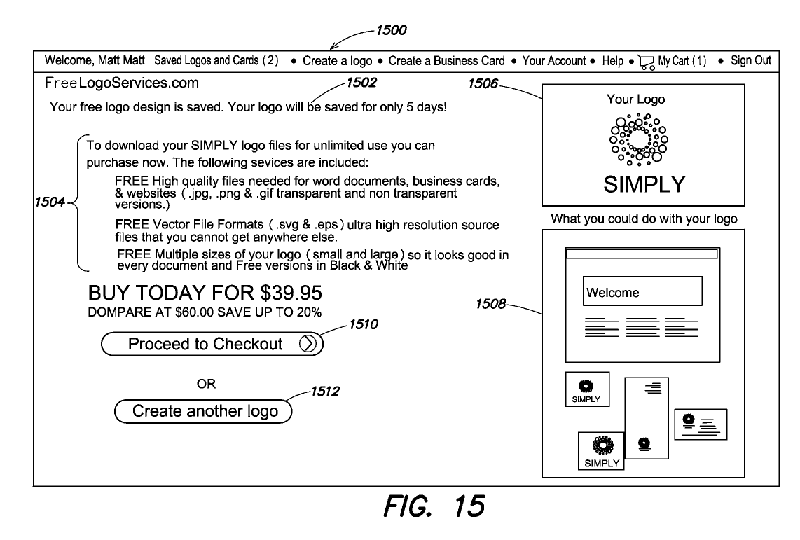

FIG. 15 is an example screen capture of a user interface 1500 for purchasing a logo design. The UI 1500 can include notices regarding how long a design will be retained on the system (e.g., at 1502). At 1504, the system displays information on what the user receives upon purchase (e.g., high quality files, file formats including—.jpg, .png & .gif, .svg & .eps (for ultra high resolution), among other options). At 1506, a display of the logo design in shown. At 1508, various options for incorporating a logo into other documents, settings, etc., can be shown. For example, at 1508 a web page layout incorporating the user's logo can be shown. Further examples, include business card previews, letterhead, among other options. Responsive to selection of 1510, the system transitions to a payment interface. Alternatively, the user can create another logo responsive to selection of 1512.

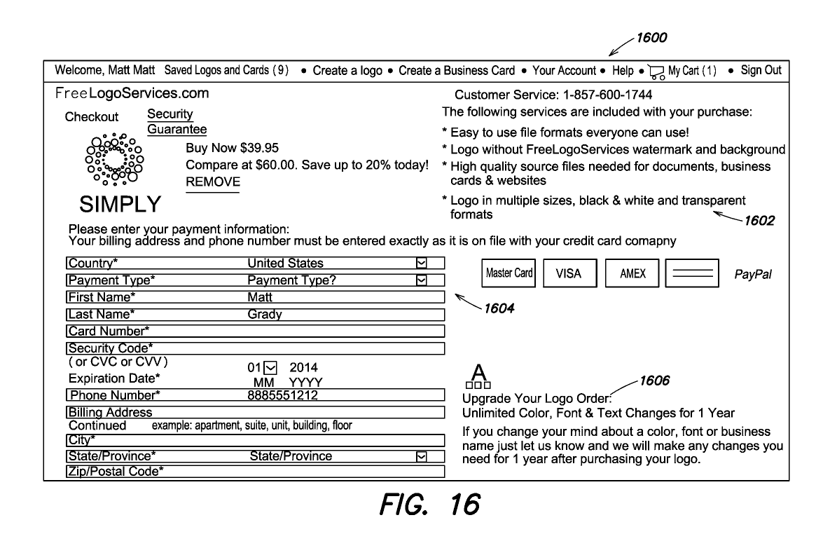

FIG. 16 is a screen capture of an example user interface 1600 for providing payment. At 1602, product details are provided for the user's purchase. At 1604 the user can specify the detail regarding their means of payment as well as add any additional features they would like to purchase (e.g., at 1606, the user can upgrade their logo purchase to include—unlimited editing of the current design, social media formatted files, recommended product selection that incorporate the logo (e.g., business cards, novelty items, etc.).

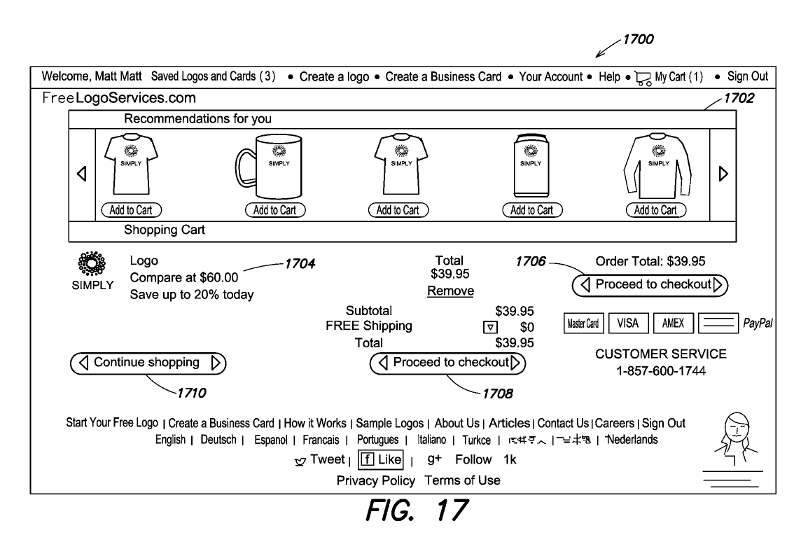

FIG. 17 is a screen capture of an example user interface 1700 for displaying a user's purchase cart. At 1702, product recommendations can be displayed to the user upon accessing the cart. The product recommendations can be automatically generated by the system. In some embodiments, the ordering of the product recommendations reflect historical user interactions of previous users and their actions (e.g., selection, view, and/or purchase, among other options) with respect to those products. In some examples, recommended products can be scores as discussed above, for example, with respect to content items or logo designs. Details of the product for purchase can be displayed at 1704. Options for proceeding to payment screens can be presented at 1706 an 1708. The user may also exit the card by selecting “continue shopping” at 1710.

Various embodiments can implements various ones of the example user interfaces discussed. Other embodiments can implement different user interfaces that provide similar functionality.

### Example Computer Implementations

Various aspects and functions described herein, in accord with aspects of the present invention, may be implemented as hardware, software, or a combination of hardware and software on one or more computer systems. There are many examples of computer systems currently in use. Some examples include, among others, network appliances, personal computers, workstations, mainframes, networked clients, servers, media servers, application servers, database servers, web servers, and virtual servers. Other examples of computer systems may include mobile computing devices, such as cellular phones, laptops, tablets, and personal digital assistants, and network equipment, such as load balancers, routers and switches. Additionally, aspects in accord with the present invention may be located on a single computer system or may be distributed among one or more computer systems connected to one or more communication networks.

For example, various aspects and functions may be distributed among one or more computer systems configured to provide a service to one or more client computers, or to perform an overall task as part of a distributed system. Additionally, aspects may be performed on a client-server or multi-tier system that includes components distributed among one or more server systems that perform various functions. Thus, the invention is not limited to executing on any particular system or group of systems. Further, aspects may be implemented in software, hardware or firmware, or any combination thereof. Thus, aspects in accord with the present invention may be implemented within methods, acts, systems, system components using a variety of hardware and software configurations, and the implementation is not limited to any particular distributed architecture, network, or communication protocol. Furthermore, aspects in accord with the present invention may be implemented as specially-programmed hardware and/or software.

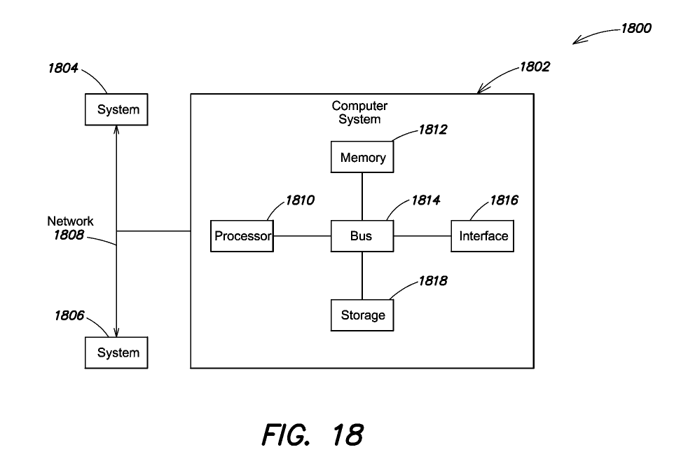

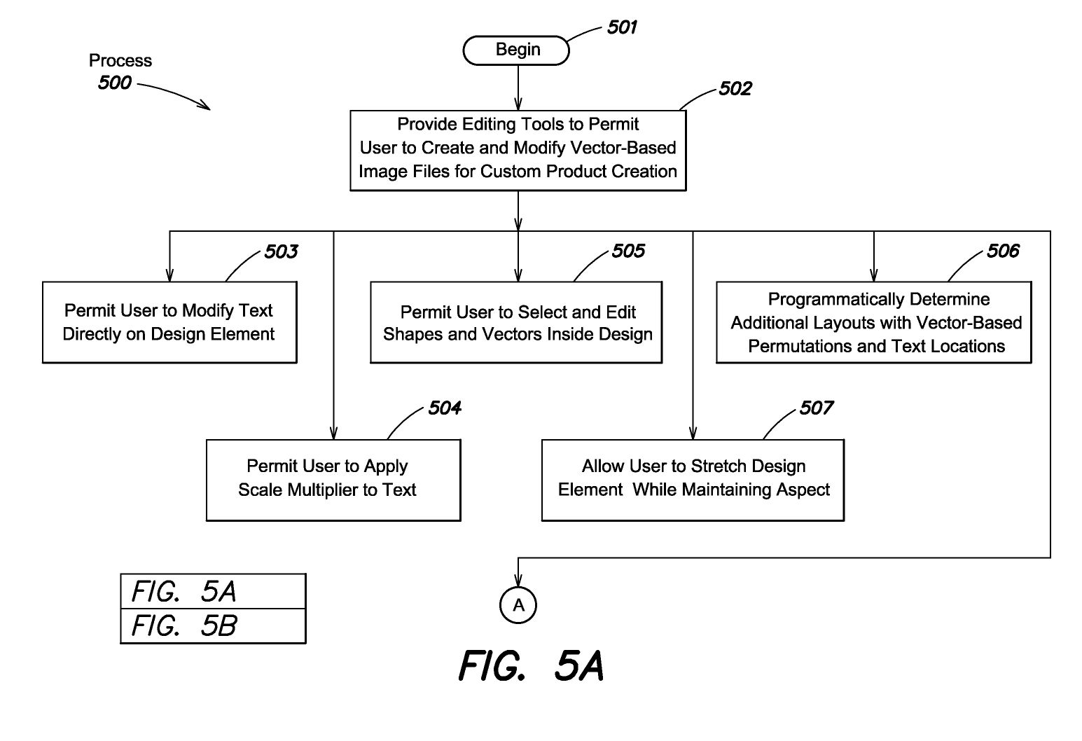

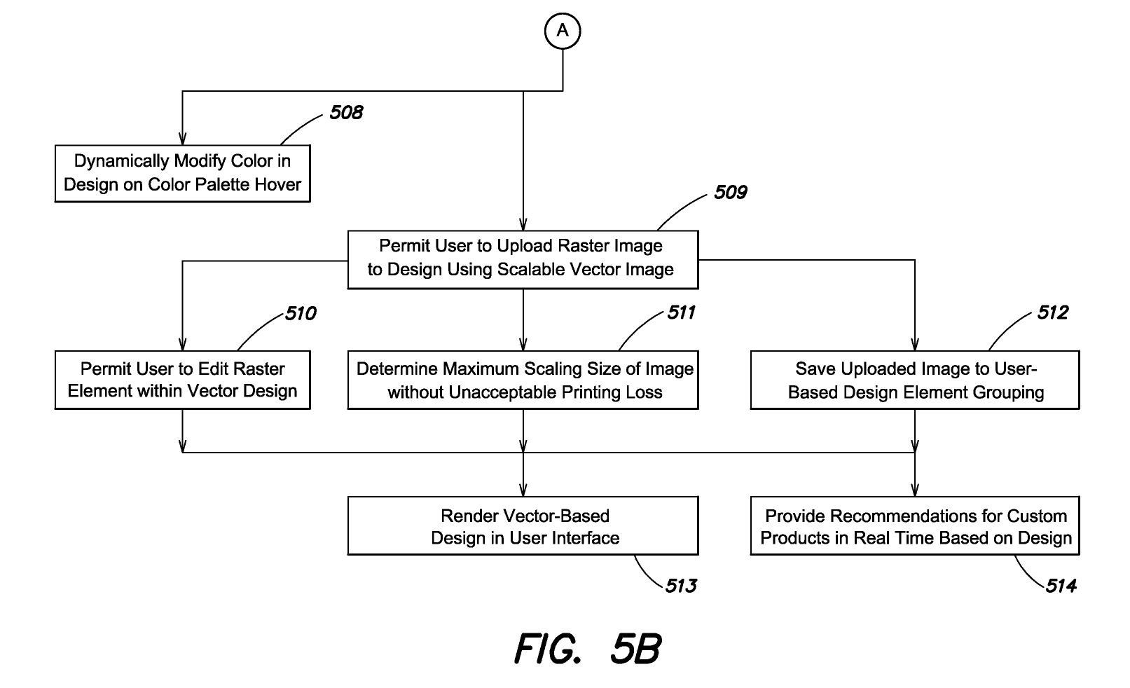

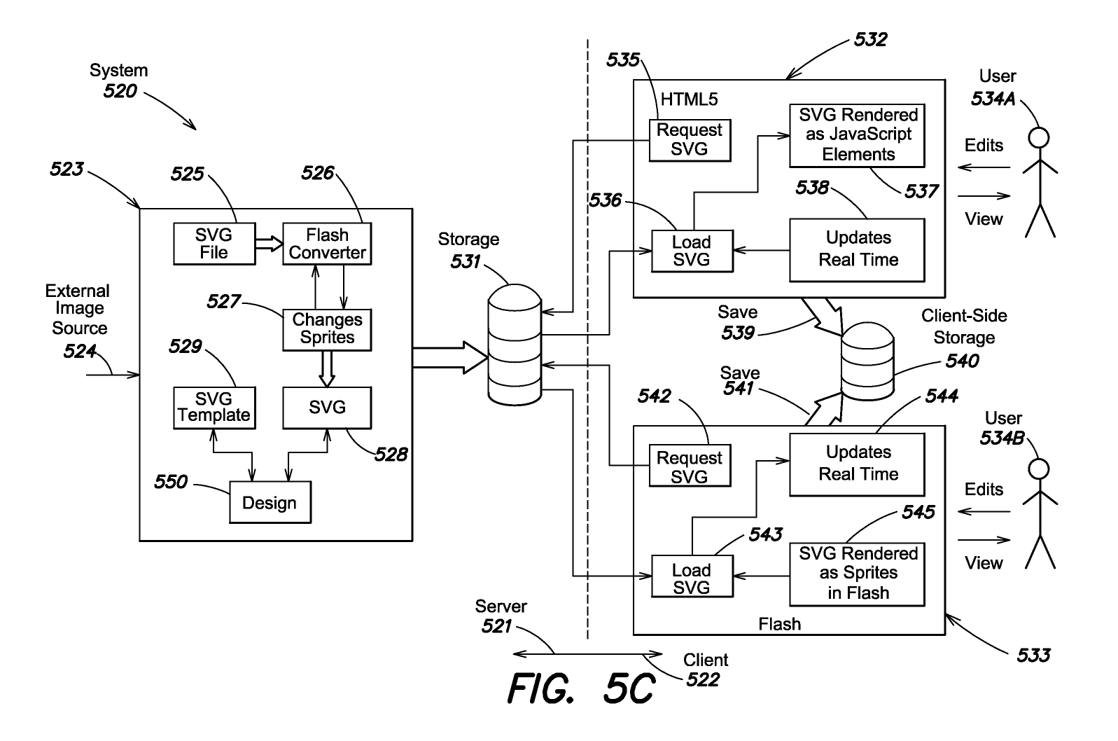

FIG. 18 shows a block diagram of a distributed computer system 1800, in which various aspects and functions in accord with the present invention may be practiced. The distributed computer system 1800 may include one or more computer systems that can be specially configured to perform the functions, operations, and/or processes disclosed herein. For example, as illustrated, the distributed computer system 1800 includes three computer systems 1802, 1804 and 1806. As shown, the computer systems 1802, 1804 and 1806 are interconnected by, and may exchange data through, a communication network 1808. The network 1808 may include any communication network through which computer systems may exchange data. To exchange data via the network 1808, the computer systems 1802, 1804, and 1806 and the network 1808 may use various methods, protocols and standards including, among others, token ring, Ethernet, Wireless Ethernet, Bluetooth, TCP/IP, UDP, HTTP, FTP, SNMP, SMS, MMS, SS7, JSON, XML, REST, SOAP, CORBA IIOP, RMI, DCOM and Web Services.

Computer systems 1802, 1804 and 1806 may include mobile devices such as cellular telephones. The communication network may further employ one or more mobile access technologies including 2nd (2G), 3rd (3G), 4th (4G or LTE) generation radio access for cellular systems, WLAN, Wireless Router (WR) mesh, and other communication technologies. Access technologies such as 2G, 3G, 4G and LTE and future access networks may enable wide area coverage for mobile devices. For example, the network may enable a radio connection through a radio network access such as Global System for Mobil communication (GSM), General Packet Radio Services (GPRS), Enhanced Data GSM Environment (EDGE), Wideband Code Division Multiple Access (WCDMA), among other communication standards. Network may include any wireless communication mechanism by which information may travel between the devices 1804 and other computing devices in the network.

To ensure data transfer is secure, the computer systems 1802, 1804 and 1806 may transmit data via the network 1808 using a variety of security measures including TSL, SSL or VPN, among other security techniques. While the distributed computer system 1800 illustrates three networked computer systems, the distributed computer system 1800 may include any number of computer systems, networked using any medium and communication protocol.

Various aspects and functions in accord with the present invention may be implemented as specialized hardware or software executing in one or more computer systems including the computer system 1802 shown in FIG. 18. As depicted, the computer system 1802 includes a processor 1810, a memory 1812, a bus 1814, an interface 1816 and a storage system 1818. The processor 1810, which may include one or more microprocessors or other types of controllers, can perform a series of instructions that manipulate data. The processor 1810 may be a well-known, commercially available processor such as an Intel Pentium, Intel Atom, ARM Processor, or may be any other type of processor or controller as many other processors and controllers are available. As shown, the processor 1810 is connected to other system placements, including a memory 1812, by the bus 1814.

The memory 1812 may be used for storing programs and data during operation of the computer system 1802. Thus, the memory 1812 may be a relatively high performance, volatile, random access memory such as a dynamic random access memory (DRAM) or static memory (SRAM). However, the memory 1812 may include any device for storing data, such as a disk drive or other non-volatile storage device, such as flash memory or phase-change memory (PCM). Various embodiments in accord with the present invention can organize the memory 1812 into particularized and, in some cases, unique structures to perform the aspects and functions disclosed herein.

Components of the computer system 1802 may be coupled by an interconnection element such as the bus 1814. The bus 1814 may include one or more physical busses (for example, busses between components that are integrated within a same machine), and may include any communication coupling between system placements including specialized or standard computing bus technologies such as IDE, SCSI, PCI and InfiniBand. Thus, the bus 1814 enables communications (for example, data and instructions) to be exchanged between system components of the computer system 1802.

Computer system 1802 also includes one or more interfaces 1816 such as input devices, output devices and combination input/output devices. The interface devices 1816 may receive input, provide output, or both. For example, output devices may render information for external presentation. Input devices may accept information from external sources. Examples of interface devices include, among others, keyboards, mouse devices, trackballs, microphones, touch screens, printing devices, display screens, speakers, network interface cards, etc. The interface devices 1816 allow the computer system 1802 to exchange information and communicate with external entities, such as users and other systems.

Storage system 1818 may include a computer-readable and computer-writeable nonvolatile storage medium in which instructions are stored that define a program to be executed by the processor. The storage system 1818 also may include information that is recorded, on or in, the medium, and this information may be processed by the program. More specifically, the information may be stored in one or more data structures specifically configured to conserve storage space or increase data exchange performance. The instructions may be persistently stored as encoded signals, and the instructions may cause a processor to perform any of the functions described herein. A medium that can be used with various embodiments may include, for example, optical disk, magnetic disk or flash memory, among others. In operation, the processor 1810 or some other controller may cause data to be read from the nonvolatile recording medium into another memory, such as the memory 1812, that allows for faster access to the information by the processor 1810 than does the storage medium included in the storage system 1818. The memory may be located in the storage system 1818 or in the memory 1812. The processor 1810 may manipulate the data within the memory 1812, and then copy the data to the medium associated with the storage system 1818 after processing is completed. A variety of components may manage data movement between the medium and the memory 1812, and the invention is not limited thereto.

Further, the invention is not limited to a particular memory system or storage system. Although the computer system 1802 is shown by way of example as one type of computer system upon which various aspects and functions in accord with the present invention may be practiced, aspects of the invention are not limited to being implemented on the computer system, shown in FIG. 18. Various aspects and functions in accord with the present invention may be practiced on one or more computers having different architectures or components than that shown in FIG. 18. For instance, the computer system 1802 may include specially-programmed, special-purpose hardware, such as for example, an application-specific integrated circuit (ASIC) tailored to perform a particular operation disclosed herein. Another embodiment may perform the same function using several general-purpose computing devices running MAC OS System X with Motorola PowerPC processors and several specialized computing devices running proprietary hardware and operating systems.

The computer system 1802 may include an operating system that manages at least a portion of the hardware placements included in computer system 1802. A processor or controller, such as processor 1810, may execute an operating system which may be, among others, a Windows-based operating system (for example, Windows 7 or Windows 8) available from the Microsoft Corporation, a MAC OS System X operating system available from Apple Computer, one of many Linux-based operating system distributions (for example, the Enterprise Linux operating system available from Red Hat Inc.), or a UNIX operating systems available from various sources. Many other operating systems may be used, and embodiments are not limited to any particular operating system.

The processor and operating system together define a computing platform for which application programs in high-level programming languages may be written. These component applications may be executable, intermediate (for example, C# or JAVA bytecode) or interpreted code which communicate over a communication network (for example, the Internet) using a communication protocol (for example, TCP/IP). Similarly, functions in accord with aspects of the present invention may be implemented using an object-oriented programming language, such as JAVA, C++, or C# (C-Sharp). Other object-oriented programming languages may also be used. Alternatively, procedural, scripting, or logical programming languages may be used.

Additionally, various functions in accord with aspects of the present invention may be implemented in a non-programmed environment (for example, documents created in HTML, XML or other format that, when viewed in a window of a browser program, render aspects of a graphical-user interface or perform other functions). Further, various embodiments in accord with aspects of the present invention may be implemented as programmed or non-programmed placements, or any combination thereof. For example, a web page may be implemented using HTML while a data object called from within the web page may be written in C++. Thus, the invention is not limited to a specific programming language and any suitable programming language could also be used.

It is to be appreciated that embodiments of the methods and apparatuses discussed herein are not limited in application to the details of construction and the arrangement of components set forth in the following description or illustrated in the accompanying drawings. The methods and apparatuses are capable of implementation in other embodiments and of being practiced or of being carried out in various ways. Examples of specific implementations are provided herein for illustrative purposes only and are not intended to be limiting. In particular, acts, elements and features discussed in connection with any one or more embodiments are not intended to be excluded from a similar role in any other embodiments.

Also, the phraseology and terminology used herein is for the purpose of description and should not be regarded as limiting. Any references to embodiments or elements or acts of the systems and methods herein referred to in the singular may also embrace embodiments including a plurality of these elements, and any references in plural to any embodiment or element or act herein may also embrace embodiments including only a single element. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms.

Having thus described several aspects of at least one embodiment of this invention, it is to be appreciated that various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A system for creating a custom design, the system comprising:
a client system including at least one processor operatively connected to a memory;
an interface configured to receive one or more inputs, the one or more inputs being used to create a design, the design including at least one vector-based design element;
wherein the memory of the client system is adapted to store the at least one vector-based design element;
a component adapted to modify the at least one vector-based design element and store the modification in the memory of the client system; and
a component adapted to render the modification of the at least one vector-based design element within the interface.

2. The system according to claim 1, wherein the component adapted to modify the at least one vector-based design element and store the modification in the memory of the client system and the component adapted to render the modification of the at least one vector-based design element within the interface are operable on the client without the need for server-based processing.

3. The system according to claim 1, wherein the at least one vector-based design element includes image information in at least one of a group of formats comprising:
Small Web Format (SWF);
Scalable Vector Graphics (SVG);
Encapsulated Postscript (EPS); and
Postscript (PS).

4. The system according to claim 1, wherein the interface configured to accept from the user a design including the at least one vector-based design element includes a browser-based interface through which the at least one vector-based design element is created.

5. The system according to claim 4, wherein the at least one vector-based design element is manipulated using a browser-based editing component.

6. The system according to claim 5, wherein the browser-based editing component is implemented using at least one of Flash programming and HTML5 programming.

7. The system according to claim 1, further comprising a preview interface that is adapted to display, in real-time, an update of the at least one vector-based design element in relation to a base custom product.

8. The system according to claim 7, further comprising a component adapted to apply a transformation to the at least one vector-based design element to display a modified at least one vector-based design element in relation to the base custom product.

9. The system according to claim 1, wherein the memory of the client system includes a cache that stores the at least one vector-based design element.

10. The system according to claim 9, wherein operations performed within the interface of the client system are applied directly to the at least one vector-based design element and updates to a displayed representation of the at least one vector-based design are performed responsive to the operations performed within the interface of the client system without receiving updates from system other than the client system.

11. The system according to claim 1, further comprising a plurality of custom product templates upon which the at least one vector-based design element may be rendered.

12. The system according to claim 11, wherein at least one of the plurality of custom product templates includes information describing a surface of a custom product, and wherein the processor applies a transformation of the at least one vector-based design element to display the at least one vector-based design element on the surface of the custom product.

13. The system according to claim 12, further comprising an interface that is adapted to display the at least one vector-based design element on the surface of the custom product to the user.

14. The system according to claim 1, further comprising a component adapted to import a raster-based image file and associating the raster-based image file with the at least one vector-based design element.

15. The system according to claim 14, wherein the component adapted to import the raster-based image file is configured to determine a maximum scaling size of the image file relative to an acceptable printing quality of a particular custom product.

16. The system according to claim 8, wherein the transformation is performed independently by the client system.

17. The system according to claim 1, further comprising a component that automatically applies a transformation to the at least one vector-based design element to render an alternative custom product for presentation to the user within the interface.

18. The system according to claim 1, further comprising a component adapted to sample one or more aspects of the at least one vector-based design element to render an alternative custom product for presentation to the user within the interface.

19. The system according to claim 18, wherein the one or more aspects of the at least one vector-based design element include a color associated with the at least one vector-based design element.

20. The system according to claim 1, further comprising a conversion component that is adapted to convert the at least one vector-based design element to an output file having a format.

21. The system according to claim 20, wherein the output file format includes a file format that can be printed on a base product by a production system.

22. The system according to claim 20, wherein the output file is capable of being downloaded to a client system.

23. The system according to claim 20, wherein the output file may be displayed within an interface of a computer system.

24. The system according to claim 20, wherein the file format includes at least one of a vector image format and a raster image format.

25. The system according to claim 1, wherein the one or more inputs include inputs provided by a user.

26. The system according to claim 1, wherein the one or more inputs include at least one of a group comprising:
an image;
a modification of an image; and
a text input.

27. The system according to claim 1, wherein the one or more inputs include inputs provided by a user.

28. The system according to claim 1, wherein the one or more inputs are received automatically by the system.

29. The system according to claim 21, wherein the conversion component operates without operator intervention.

30. A method for designing a custom product, the method comprising acts of:
receiving one or more inputs;
creating, using the one or more inputs, a design of at least one custom product, the design including at least one vector-based design element;
storing, in a memory of the client system, the at least one vector-based design element;
modifying the at least one vector-based design element and storing the modification in the memory of the client system; and
rendering the modification of the at least one vector-based design element within the client interface.

31. The method according to claim 30, wherein the acts of modifying the at least one vector-based design element, storing the modification in the memory of the client system and rendering the modification of the at least one vector-based design element within the client interface are operable on the client system without the need for server-based processing.

32. The method according to claim 30, wherein the at least one vector-based design element includes image information in at least one of a group of formats comprising:
Small Web Format (SWF);
Scalable Vector Graphics (SVG);
Encapsulated Postscript (EPS); and
Postscript (PS).

33. The method according to claim 30, wherein the client interface includes a browser-based interface through which the at least one vector-based design element is created.

34. The method according to claim 33, further comprising an act of manipulating the at least one vector-based design element using a browser-based editing component.

35. The method according to claim 34, wherein the browser-based editing component is implemented using at least one of Flash programming and HTML5 programming.

36. The method according to claim 30, further comprising an act of displaying, in real-time, an update of the at least one vector-based design element in relation to a base custom product.

37. The method according to claim 36, further comprising an act of applying a transformation to the at least one vector-based design element to display a modified at least one vector-based design element in relation to the base custom product.

38. The method according to claim 30, further comprising an act of storing, in a cache associated with the memory of the client system, the at least one vector-based design element.

39. The method according to claim 38, further comprising applying operations performed within the interface of the client system directly to the at least one vector-based design element and updating a displayed representation of the at least one vector-based design responsive to the operations performed within the interface of the client system without receiving updates from system other than the client system.

40. The method according to claim 30, further comprising maintaining a plurality of custom product templates upon which the at least one vector-based design element may be rendered.

41. The method according to claim 40, wherein at least one of the plurality of custom product templates includes information describing a surface of a custom product, and wherein the method further comprises an act of applying a transformation of the at least one vector-based design element to display the at least one vector-based design element on the surface of the custom product.

42. The method according to claim 41, further comprising an act of displaying the at least one vector-based design element on the surface of the custom product to the user.

43. The method according to claim 30, further comprising an act of importing a raster-based image file and associating the raster-based image file with the at least one vector-based design element.

44. The method according to claim 43, further comprising an act of determining a maximum scaling size of the raster-based image file relative to an acceptable printing quality of a particular custom product.

45. The method according to claim 38, wherein the transformation is performed independently by the client system.

46. The method according to claim 30, further comprising an act of automatically applying a transformation to the at least one vector-based design element to render an alternative custom product for presentation to the user within the interface.

47. The method according to claim 30, further comprising an act of sampling one or more aspects of the at least one vector-based design element to render an alternative custom product for presentation to the user within the interface.

48. The method according to claim 47, wherein the one or more aspects of the at least one vector-based design element include a color associated with the at least one vector-based design element.

49. The method according to claim 30, further comprising an act of converting the at least one vector-based design element to an output file having a format.

50. The method according to claim 49, wherein the output file format includes a file format that can be printed on a base product by a production system.

51. The system according to claim 49, wherein the output file may be downloaded to a client system.

52. The method according to claim 49, further comprising displaying the output file within an interface of a computer system.

53. The method according to claim 49, wherein the file format includes at least one of a vector image format and a raster image format.

54. The method according to claim 30, wherein the one or more inputs include inputs provided by a user.

55. The method according to claim 30, wherein the one or more inputs include at least one of a group comprising:
an image;
a modification of an image; and
a text input.

56. The method according to claim 30, wherein the one or more inputs include inputs provided by a user.

57. The method according to claim 30, wherein the one or more inputs are received automatically.

58. The method according to claim 43, wherein the conversion component operates without operator intervention.
